(19) United States
(12) Patent Application Publication
(10) Pub. No.: US 2026/0137094 A1
(43) Pub. Date: May 21, 2026

(54) OVEN AND SMOKER DEVICE

(71) Applicant: CARTER-HOFFMANN, LLC, Mundelein, IL (US)

(72) Inventors: James K. Pool, III, Mundelein, IL (US); Carol Lessard, Mundelein, IL (US); Matt Deming, Mundelein, IL (US); Sreekanth Pushpala, Mundelein, IL (US); Gwen Bialas, Mundelein, IL (US)

(21) Appl. No.: 19/394,120

(22) Filed: Nov. 19, 2025

Related U.S. Application Data
(60) Provisional application No. 63/723,547, filed on Nov. 21, 2024.

(51) Int. Cl. A23B 4/052; F24B 13/04; F24C 15/32

(52) U.S. Cl. CPC A23B 4/052; F24B 13/04; F24C 15/322

(57) ABSTRACT

A cabinet configured to warm and/or hold warmed food product in provided. The cabinet includes a housing with an enclosure and supports a door. The enclosure includes a first air flow path established outside of a left side wall, a second air flow path established outside of a right side wall, a third air flow path established outside of a rear wall, and a fourth air flow path established within a door. An air flow plenum is disposed above the ceiling, and configured to receive air that flows upwardly through the third air flow path when the door is in the closed position and the fourth air flow path. A fan is disposed within the housing, the fan disposed above the ceiling and configured to, when operating, to draw suction from the air flow plenum, the fan further configured to discharge air into the first air flow path and the second air flow path in parallel. The cabinet further includes a secondary housing with a combustion chamber where combustion air can flow to the enclosure.

### CROSS-REFERENCE TO RELATED APPLICATIONS

This application claims priority from U.S. Provisional Application No. 63/723,547 filed on Nov. 21, 2024, the entirety of which is hereby incorporated by reference herein.

### BACKGROUND OF THE INVENTION

This application is directed to a holding cabinet that is configured act as an oven or hold food product therein for an extended period of time and in a controlled and heated environment.

### SUMMARY OF THE INVENTION

A first representative embodiment of the disclosure is provided. The first representative embodiment is a cabinet that is configured to warm and/or hold warmed food product. The cabinet includes a housing with an enclosure to receive and retain food product therein in a warmed condition, the housing supporting a door that can be disposed in an open position to allow access to the enclosure and can be disposed in a closed position to prevent access to the enclosure. The enclosure includes a left side wall, a right side wall, a rear wall, a ceiling and a floor, a first air flow path established outside of the left side wall, a second air flow path established outside of the right side wall, a third air flow path established outside of the rear wall, and a fourth air flow path established within the door. An air flow plenum is disposed above the ceiling, and configured to receive air that flows upwardly through the third air flow path when the door is in the closed position and the fourth air flow path. A fan is disposed within the housing, the fan disposed above the ceiling and configured to, when operating, to draw suction from the air flow plenum, the fan further configured to discharge air into the first air flow path and the second air flow path in parallel.

A second representative embodiment of the disclosure is provided. The first representative embodiment is a holding cabinet configured to warm and/or hold warmed food product. The first housing has an enclosure to receive and retain food product therein in a warmed condition and a second housing is outboard of and attached to the first housing. The second housing includes a combustion chamber disposed therein, and a first outlet that is fluidly connected to the first housing, the first outlet configured to allow air from the combustion chamber to flow into the enclosure, the second housing further comprising an air inlet that allows outside enter to enter into the combustion chamber. The second housing includes a first door that is disposed proximate to the first outlet, such that when the first door is in an open position air can flow from the combustion chamber toward the enclosure and when the first door is in a closed position air is prevented from flowing from the combustion chamber toward the enclosure. A second door that is disposed proximate to the air inlet, such that when the second door is in an open position air can flow from outside of the second housing and into the second housing, and when the second door is in a closed position air is prevent from flowing into the second housing. The first door and the second door are operated concurrently such that the first and second doors are both in the closed position or the first and second doors are both in the open position.

A third representative embodiment of the disclosure is provided and a cabinet configured to warm and/or hold warmed food product. The cabinet includes a housing with an enclosure to receive and retain food product therein in a warmed condition. A second housing is outboard of and attached to the housing. The second housing includes a combustion chamber disposed therein, and a first outlet that is fluidly connected to a receipt plenum of the housing, the second housing further comprising an air inlet that allows outside enter to enter into the combustion chamber.

Additional representative embodiments of the disclosure are provided and are commiserate with Numbered Paragraphs 1-35 provided at the end of this specification as well as any combination of the elements provided in Numbered Paragraphs 1-35.

Advantages of the present disclosure will become more apparent to those skilled in the art from the following description of the preferred embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF DRAWINGS

FIG. 1 is a perspective view of a cabinet configured for dual fuel heat generation. The cabinet is configured to operate as an oven, a holding cabinet for receiving already baked/cooked food therein and maintain in a warmed condition, and a smoker for holding food in a flavored smoke environment.

FIG. 2 is a perspective view of the cabinet of FIG. 1 with a portion of the door of the cabinet hidden.

FIG. 3 is a different perspective view of the view of FIG. 2.

FIG. 4 is a perspective view of the enclosure within the cabinet of FIG. 1.

FIG. 5 is a cross-sectional perspective view of the enclosure of FIG. 4 along the section KK-KK of FIG. 4.

FIG. 6 is a perspective view of an inner surface of the door of the cabinet of FIG. 1.

FIG. 7 is another perspective view of the enclosure of FIG. 4.

FIG. 8 is a perspective view of a secondary cabinet that is fixed to the cabinet, the secondary cabinet is configured for generating heat through combustion.

FIG. 9 is a top perspective view of the secondary cabinet of FIG. 8 with the top door removed.

FIG. 9A is top perspective view of section MM-MM of FIG. 9.

FIG. 10 is a perspective view of an inner portion of the secondary cabinet (that faces the cabinet 10) that depicts the first door (230) and the second door (270) in the closed positions.

FIG. 10A is a view of detail DD of FIG. 10.

FIG. 11 is the view of FIG. 10 depicting the first and second doors in the open positions.

FIG. 11A is a view of detail EE of FIG. 11.

FIG. 12 is a perspective cross-sectional view of section NN-NN of FIG. 8.

FIG. 13 is a side perspective view of a side of portion of the secondary housing with the side door (202) removed.

FIG. 14 is a perspective view of the rack (305) of the secondary housing.

FIG. 14A is a lower perspective view of the rack of FIG. 14.

FIG. 15 is a perspective view of the secondary housing in an embodiment where a handle of the follower extends out of the top door of the housing.

FIG. 16 is a top perspective view of the secondary housing of FIG. 15 with the top door removed.

FIG. 17 is a side cross-sectional view of section GG-GG of FIG. 16.

FIG. 18 is a perspective view of an inner portion of the secondary cabinet like FIG. 10, but with an alternate door movement mechanism depicting the first and second doors in the open position.

FIG. 18A is a view of detail CC of FIG. 18.

### DETAILED DESCRIPTION OF THE INVENTION

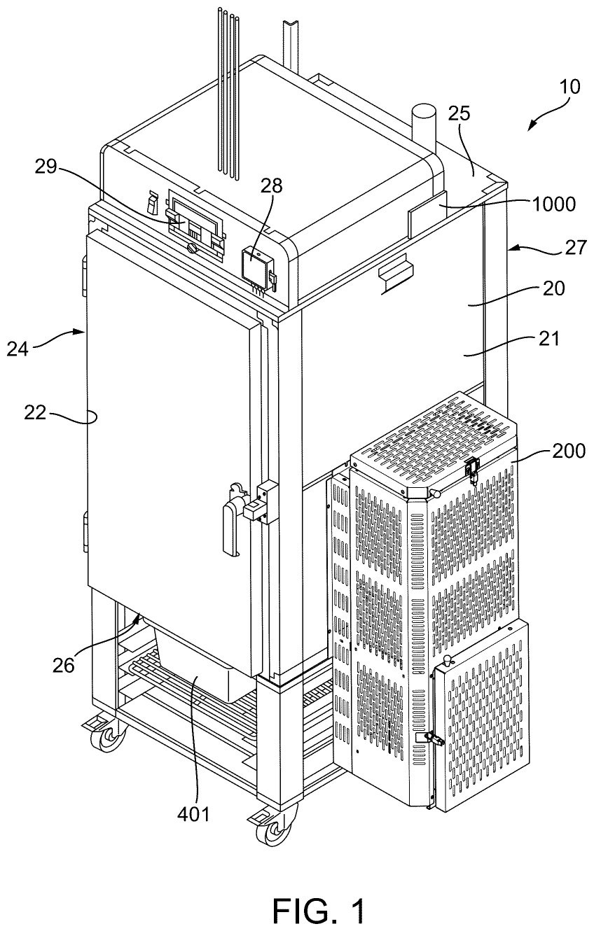

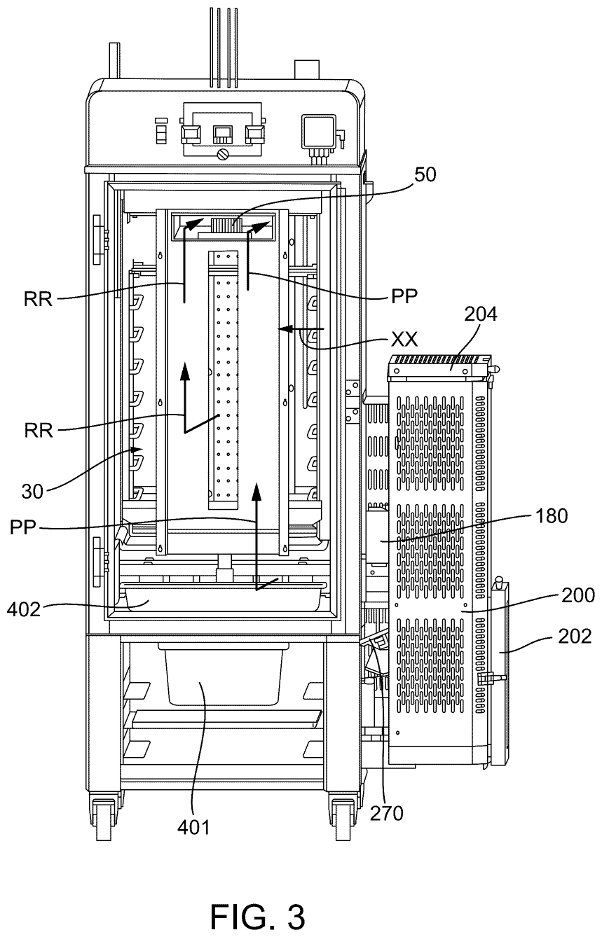

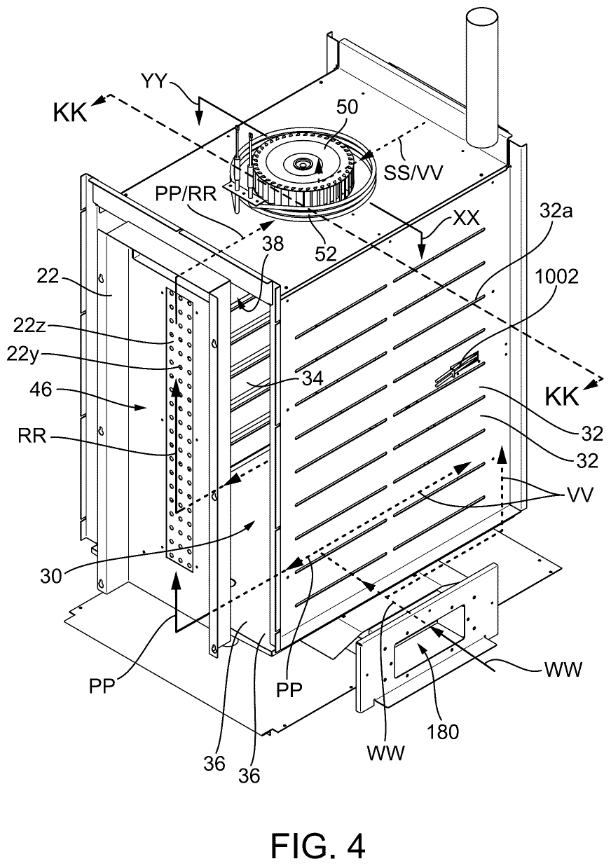

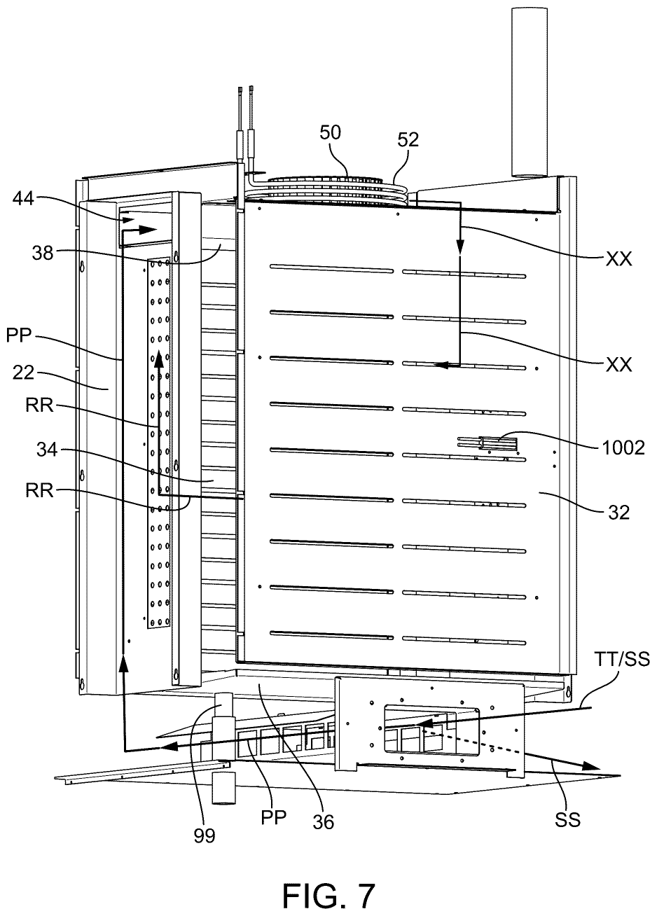

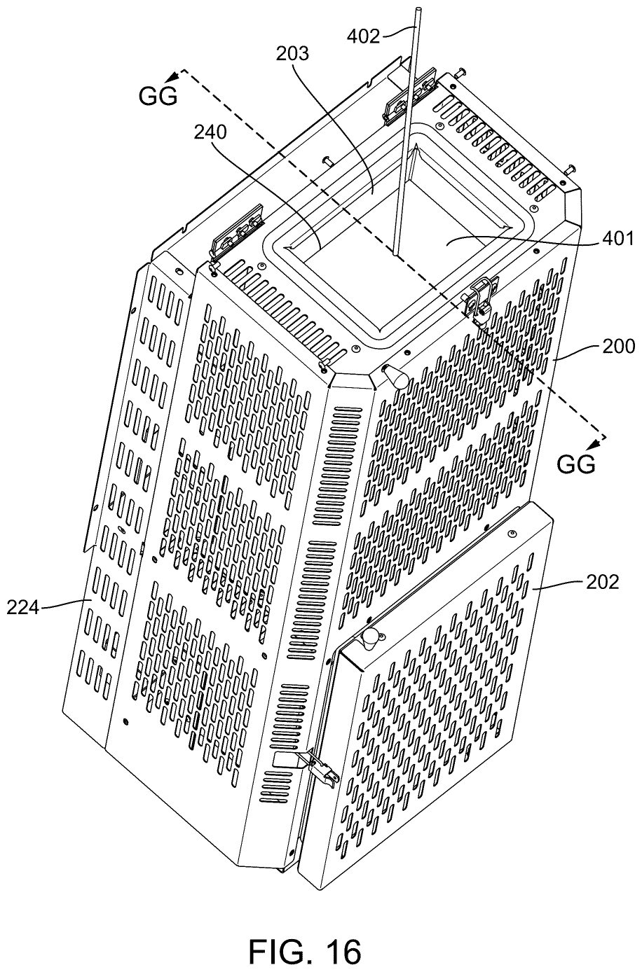

Turning to FIGS. 1-18A, a holding cabinet 10 is provided. The cabinet 10 is configured to perform one or several functions—such as acting as an oven to cook/bake/heat food received therefrom from a first temperature to a hotter temperature, and to hold warmed food products therein (either received in a warmed or cooked condition or to maintain food product that is cooked/baked/heated within the cabinet when the cabinet acted as an oven, as well as to cook/bake/heat/hold food in a warmed condition and in the presence of flavored smoke that flows therein with combustion within the cabinet. The cabinet in sometimes referred to as a “holding cabinet” herein, but the term is not intended to be limiting and instead is to include the use of the cabinet also or instead as an oven for cooking/baking/heating as a smoker to maintain the food within the enclosure within a smoke filled environment to transfer flavor from the smoke to the food. The cabinet 10 is configured to have a “dual fuel” heating source such that heat that is supplied within a food holding enclosure 30 is selectively from an electric heater 52 or from air heated due to combustion that occurs within a second housing 200 that is fixed adjacent to the food holding enclosure 30. In some embodiments, the heat that is supplied within the food holding enclosure 30 is from both the electric heater 52 and the combustion air from the second housing 200.

The enclosure 30 may be configured to receive and store food product therein upon pans (500, schematic) that can be supported therein with supports 33, 35 that are disposed upon respective left side and right side walls 32, 34 that form the enclosure 30. Alternatively the food may be stored upon racks that are fixed within the enclosure. The enclosure 30 configured such that a plurality of pans or racks are disposed simultaneously within the enclosure 30 in a vertical arrangement. As discussed below, the enclosure 30 a plurality of apertures disposed in the walls thereof to direct heated air flow within the enclosure in order to interact with the food product disposed therein.

The enclosure 30 is disposed within a first housing 20. The first housing includes outer walls that form that outside barrier of the housing, including an outer left wall 21, and outer right wall (24, not shown in FIG. 1, but similar to outer left wall 22), an upper wall 25, and a lower wall 26, and a rear wall 27. The enclosure has inner walls that are spaced from the respective adjacent outer walls, and as discussed below, several air flow paths are established between the outer walls and the adjacent inner walls that directly establish the boundaries of the enclosure. The housing 20 may have, for example, insulation that is disposed outside of the various flow paths that provides for minimizing the heat loss from within enclosure 30 and out of the housing 20 to the environment.

The enclosure 30 is described and depicted herein as being a typical “box shaped” enclosure with parallel opposite walls and adjacent walls that are perpendicular with each other. The enclosure, and the overall housing, may be formed with different shapes that may be desired for various storage applications, or for purely ornamental reasons, and one of ordinary skill in the art with a thorough review of this specification would readily understand how to modify the enclosure 30 from the version specifically described and depicted herein to achieve other desired geometries with merely routine optimization. For the sake of brevity a housing 20 and enclosure 30 that is with a typical box shape is disclosed in detail herein.

The enclosure 30 is formed from a left wall 32 and opposite right wall 34, which are preferably parallel to each other. The enclosure has a rear wall 40 and an upper wall 38, and a lower wall 36. The rear wall 40 may be planar along its entire length, or in other embodiment may have different planar surfaces that are offset in parallel from each other—such as a central portion 40a—that extends vertically that is further inboard within the enclosure than portions that are outboard of the central portion. In the embodiments depicted in the figures the central portion 40a is along the same plane as the remaining portions of the rear wall to minimize any decrease of the volume of the enclosure 30 to receive pans and racks therein. The upper wall 38 may be planar along its entire surface, and in some embodiments as depicted in the figures, the upper wall may be formed from different portions (i.e. a central portion 38a, and outboard portions 38b) that are at different heights within the enclosure above the lower wall 36. The central portion 38a and outboard portions 38b may be parallel to each other. The lower wall 36 may be planar, or in preferred embodiments, may have one or more angled portions (i.e. with a small acute angle with respect to a floor or surface that housing rests upon) to guide liquid upon the lower wall to flow to a drain 99 due to gravity.

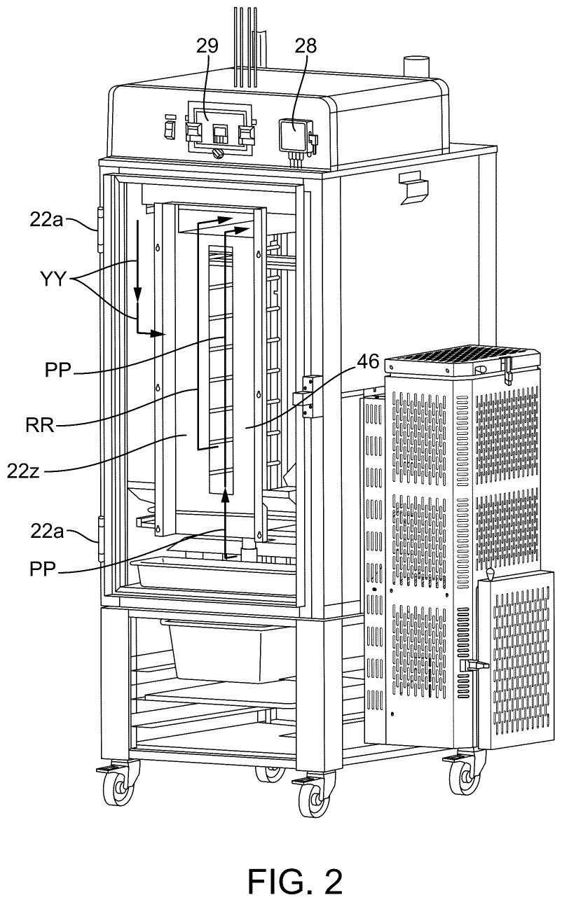

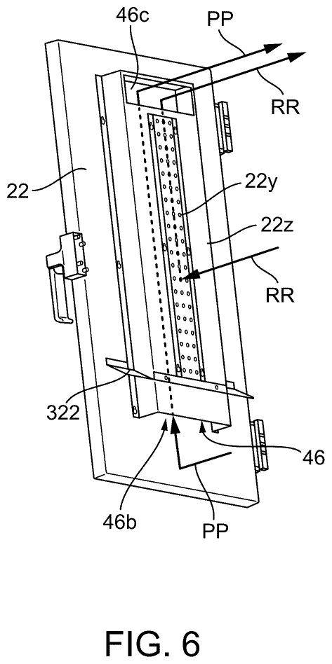

A door 22 is rotatably mounted to the housing 20 and can be in closed position (FIG. 1) to isolate the enclosure 30 and an open position (not shown, but pivoted along the hinges 22a as is well known in the art to allow for access the enclosure 30 such as to insert or remove food product from within the enclosure 30, or to insert to remove pans or trays (500) from within the enclosure. The door 22 includes a front flow plenum 46 (FIGS. 2, 6) that allows air to flow therethrough and specially vertically therealong, with flow paths PP and RR discussed below. The front flow plenum 46 has an inner barrier 22z that establishes a portion of a front surface of the enclosure. The inner barrier 22z may include a plurality of apertures 22y that allows air from within the enclosure 30 to flow therethrough and into the front flow plenum 46, as depicted in flow path RR. The front flow plenum 46 leads to an upper plenum 44 above the upper wall.

As discussed above, the rear wall 40 includes a central portion 40a. The central portion 40a includes a plurality of apertures 40y that leads to a rear plenum 48 (disposed behind the central portion 48 and between the rear wall 40 and the outer rear wall of the housing 27). The rear plenum 48 leads to an upper plenum 44 above the upper wall 38. Air from within the enclosure 30 can flow through the plurality of apertures 40y and into the rear plenum 48 (air flow TT), and air that exits the receipt plenum 80 through the second set of apertures 184 (air flow SS) (discussed below) also flows through the rear plenum.

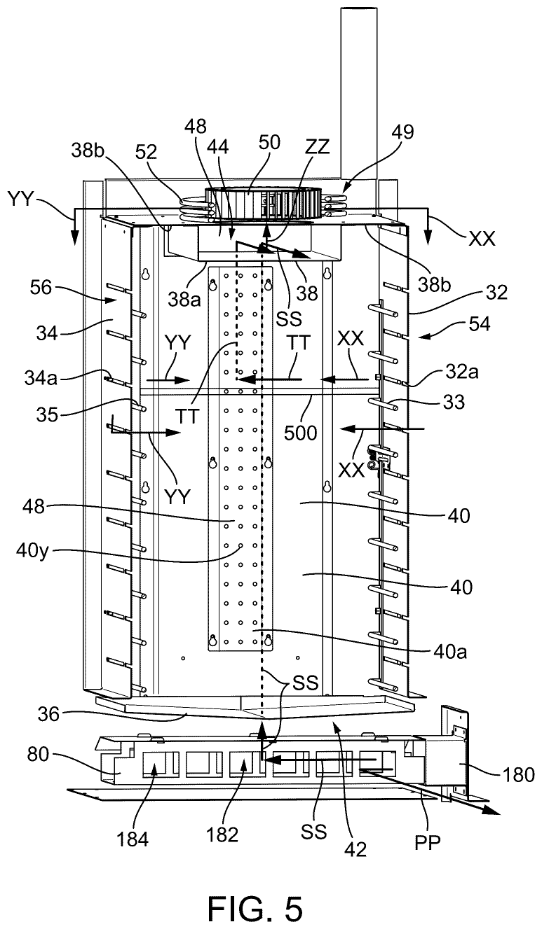

With reference to FIGS. 2-6, the air flow paths through the housing 20 and the enclosure 30 can be best understood and are depicted schematically. Air flow WW (all air flows depicted are schematic) enters into the housing 20 through a plenum 180 from the second housing 200 that includes a combustion chamber 310, discussed below. This air WW from the combustion chamber is heated combustion air and may include smoke and flavored smoke from the second housing to flavor the food product within the enclosure as in the operation of a smoker device. Air WW that enters the housing 20 from the plenum 180 and flows into in a receipt plenum 80 within the housing 20. The receipt plenum 80 includes a first plurality of holes 182 that face a front portion of the housing 20 and the door 22, and a second plurality of holes 184 that face a rear portion of the housing and the rear wall 27. Air leaves the receipt plenum 80 via the first plurality of holes 182 via air flow path PP, and air leaves the receipt plenum 80 vis the second plurality of holes 184 via air flow path SS (FIG. 5). Air flow PP flows to the front flow plenum 46 through an inlet 46b and flows vertically therethrough and out of an outlet 46c in the front flow plenum 46c. The outlet 46c (when the door 22 is closed, as it is during operation of the various air flows within the housing 20) is aligned with an inlet into the upper plenum 44.

As discussed above, air also flows through the plurality of apertures 22y from the enclosure 30 and into the front flow plenum 46 as depicted as air flow RR, and when combustion air flows though the plenum (PP) air also flows through the apertures 22y (RR). The air flow RR flows upwardly through the front flow plenum 46 and into the upper plenum 44.

Air that flows out of the second plurality of holes 146 in the receipt plenum 80 flows rearwardly through the housing 20 (air flow SS) and into the rear plenum 48 through an inlet (similar to the inlet 46b of the front flow plenum 46) and flows vertically through the rear plenum 48 (as depicted schematically with a broken line in FIG. 5). Air flows from the enclosure 30 and through the plurality of holes 40y and into the rear plenum 48 as depicted with air flow TT (FIG. 5). Similar to the first flow plenum 46 within the door, and when combustion air flows through the plenum (SS) air also flows through the apertures 40y and into the rear plenum 48 (TT). The air flow TT also flows vertically within the rear flow plenum and out a hole (similar to the outlet 46c of the front flow plenum 46) and into the upper plenum 44.

The upper plenum 44 is disposed above the enclosure 30 and a bottom surface thereof may form a part of the top wall 38 of the enclosure 30. The housing 20 supports a fan 50 that when operating draws a suction from the upper plenum 44 to urge air into the intake of the fan 50. This suction 50 is communicated through the upper plenum and into each of the front flow plenum 46 and the rear flow plenum 48 to urge the various air flow paths, PP, RR, SS, TT discussed above.

The fan 50 discharges air into a top plenum 49 that is above the upper plenum, and above the remainder of the top wall 38—as depicted schematically in FIG. 5 as air flows YY and XX. Air flow YY is directed to a right side plenum 56 that is between the right wall 34 and a right outer wall of the housing 24, and outside of the right wall 34. The right side plenum 56 may be established by another wall (not shown) that is outboard of the right wall 24 of the enclosure and the outer right wall of the housing 24. Similarly, air flow XX is directed to a left side plenum 54 that is between the left wall 32 and a right outer wall of the housing 21, and outside of the left wall 32. The right side plenum 54 may be established by another wall (not shown) that is outboard of the right wall 32 of the enclosure and the outer right wall of the housing 21. Each of the right and left walls 24, 21 include a plurality of respective apertures 32a, 32a that allow air flow from the respective right and left side plenums 56, 54 and into the enclosure (as depicted schematically with air flows YY and XX in FIG. 5). The apertures 34a, 32a are arranged throughout the respective right and left walls to allow for air to flow into all portions of the enclosure 30. In some embodiments, the spacing and size of the apertures may vary along the length of the walls (with larger and/or more apertures approaching a lower portion of each wall and smaller and/or less apertures approaching the top portion of each wall to attempt to balance out the mass flow rate of air flow YY, XX through the apertures 34a, 32a that are positioned further or closer to the top plenum 49.

The right and left walls 24, 21 preferably include support features 35, 33 to support trays or racks (500, schematic) thereon within the enclosure. In some embodiments, the apertures are positioned such that air flow into the enclosure from the apertures 34a, 32a extends just above a tray/rack when positioned within the enclosure across the right and left walls to cause the air to interact directly with food products that are disposed upon the pan/rack. In some embodiments, apertures are positioned below the support features 35, 33 such that air leaving those apertures flows directly under the pan/rack to provide heat transfer to a bottom surface of the pan/rack by convection, which is transferred to the food product resting upon the pan/rack by conduction. In the case of a rack, the air that flows out of the apertures directly under the rack may directly interact with the food via convection heat transfer.

In some embodiments, the inner surface of the door 22 may include a baffle 322 that directs any liquid that reaches the inner surface of the door 22 and flows along the door surface downwardly due to gravity to be directed onto the lower wall 36 by gravity at a position that is inboard of the door 22. This may assist with preventing any liquid from pooling close to the front edge of the enclosure 30 which could flow out of the enclosure 30 when the door is opened. With the baffle 322, the liquid that drips or flow off of the baffle 322 is directed to the lower wall and toward a drain 99.

The drain 99 may include a drain pipe 99 that extends from the drain in the lower wall 36 and downwardly to direct liquid into a drainage tank 401 that is disposed within the housing but below the enclosure 30. The drainage tank 401 may be slidable forwardly within the housing 20 to allow either the drainage tank to be removed from the housing, or in some embodiments, the drainage tank 401 may include a drainage valve that can be accessed (to allow the contents of the drainage tank 401 to drain therefrom) when the drainage tank 401 is slid forwardly with respect to the housing.

The enclosure 30 may receive a pan 402, which may be proximate to the front opening of the enclosure 30 but open to the enclosure. The pan 402 may be provided to be filled with water, which would boil or evaporate when the environment within the enclosure is hot enough for boiling to raise the humidity within the enclosure when desired for high humidity food storage. The baffle 322, when provided, extends further inboard within the enclosure than the pan 402 to prevent liquid that flows or drips off of the baffle from flowing into the pan 402.

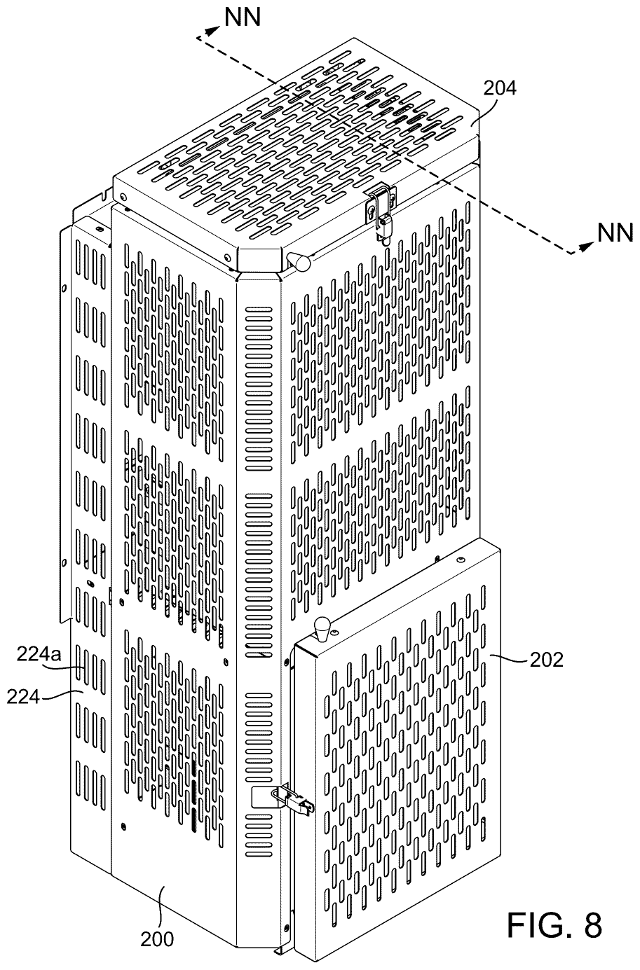

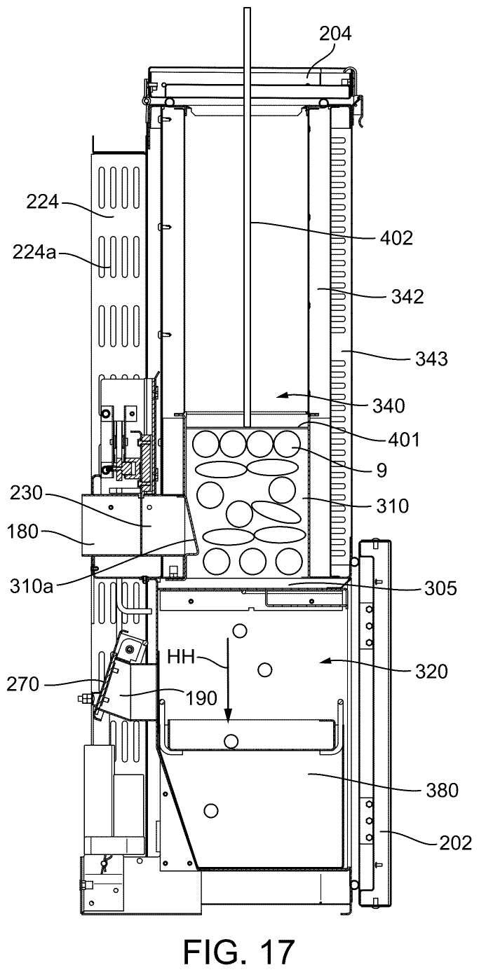

Turning now to FIGS. 8-17 the secondary housing 200 is provided. The secondary housing 200 is configured to burn combustible (food safe) material (9, FIG. 17, schematic) that is disposed therein to be burned herein with combustion heat and smoke from the combustion process flowing into the enclosure 30 to provide a heat input and in some embodiments flavoring to the food products disposed within the enclosure 30, such as various flavors that can be provided by a conventional smoking device.

The secondary housing 200 includes a combustion chamber 310, a storage chamber 340 disposed above the combustion chamber 310, an air inlet space 320, and an auxiliary chamber 380 that is disposed below the combustion chamber 310.

The secondary housing 200 includes an air outlet 180 and an air inlet 190 that allow for air to, respectively, leave and enter the secondary housing 200. Air flow through the respective air outlet 180 and air inlet 190 are controlled by respective doors 230, 270 that are discussed below. The position of the doors 230, 270 may be controlled by a controller 1000, which may be air flow controller 1000 that is discussed below or may be a separate controller. The controller 1000 for the doors 230, 270 may be in communication with the air flow controller 1000 or may operate separately therefrom.

The secondary housing 200 is fixed to the holding cabinet 10, such that air that flows from the combustion chamber 310 flows through the air outlet 180 and into the first housing 20 and ultimately into the enclosure 30. The air flow paths for air upon entering the first housing 20 from the air outlet 180 is discussed above. The air outlet 180 and the door 230 (discussed in further detail below) is positioned within the secondary housing 200 such that air flow through the air outlet 180 and into the first housing 20 does not flow through the outside environment, but instead flows internally from the secondary housing 200 to the first housing. The secondary housing 200 may include insulation layers 342 disposed between the air outlet and the outer walls of the secondary housing that are aligned with the air outlet 180 to minimize heat transfer from the hot air that flows through the air outlet 180 to the environment surrounding the secondary housing 200.

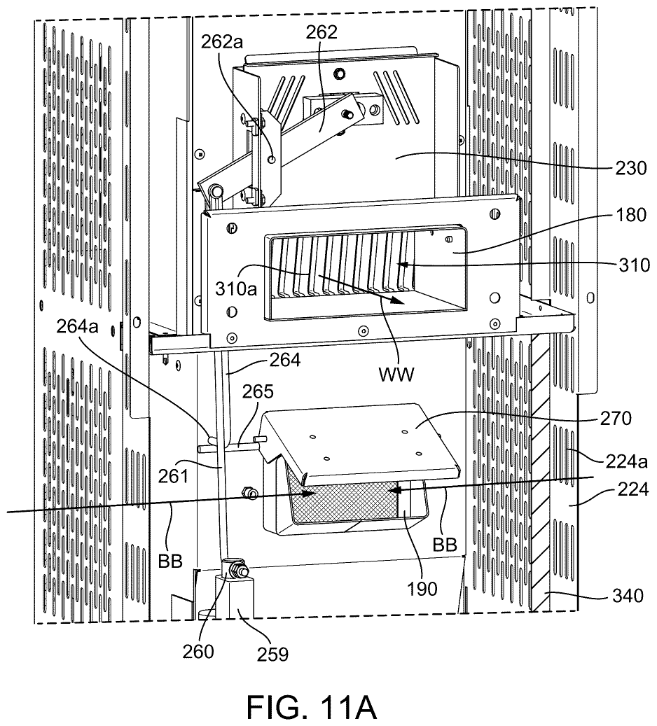

The air inlet 190 is provided to allow clean air (i.e. outside air that is drawn into the secondary housing) to enter into the secondary housing and specifically to the combustion chamber 310. The secondary housing 200 includes an outer wall 224 proximate to the air inlet that includes a plurality of apertures 224a that allows outside air to flow therethrough and into the air inlet 190, as schematically depicted as air flow BB in FIGS. 11 and 11A.

In some embodiments, the combustion chamber 310 is disposed within the secondary housing 200 and is disposed proximate to the air outlet 180, such that air flows (when the door 230 is open) directly from combustion chamber 310 and into the air outlet. A screen 310a may be disposed across the air outlet 180 to prevent particles or solids from flowing out of the combustion chamber 310 and into the air outlet, but to freely (i.e. with very low air resistance) allows combustion air and smoke (discussed below) to flow out of the combustion chamber 310 and into the air outlet 180.

The storage space 340 is disposed above the combustion chamber 310. In some embodiments, the two spaces are positioned in a vertically aligned manner such that combustible material (charcoal, wood, pellets, etc.) (FIG. 17, element 9) are positioned within the combustion chamber 310 and then further combustible materials are stacked on top of those within the combustion chamber to extend within a the storage space 340. The storage space 340 may be the same cross-sectional area and geometry as the cross-sectional area and geometry (along parallel horizontal cross-sections that are parallel to the floor or surface that the housings 20, 200 rest upon). In other embodiments, the storage space 340 may have a smaller or larger cross-sectional area, and/or a different geometry than the horizontal cross-section through the combustion chamber 310. The function of the storage space 340 is to provide replacement extra combustible material (9) that can replace the combustible material within the combustion chamber 310 after the initial combustible material within the combustion chamber sufficiently burns to be rendered into ash or small sizes that falls through the rack apertures (HH, FIG. 17) (discussed below), with the replacement combustion material falling into the combustion chamber 310 due to the force of gravity. It has been experimentally determined that, because there is minimal air flow upwardly above the combustion chamber 310 and into the storage space 340 that minimal amount of combustion material that is retained within the storage space 340 burns while it is in the storage space—even in embodiments where there is no structure within the secondary housing 200 that separates the combustion chamber 310 from the storage space 340 vertically.

The secondary housing 200 surrounding the combustion chamber 310, and in some embodiments also surrounding the storage space 340, may be provided with one more insulating layers (342) outboard of the combustion chamber and within an outer surface of the secondary housing 200, to minimize the flow of heat out of the combustion chamber 310 and to the environment—both for the purpose of efficiency (i.e. minimizing the combustion heat loss to the environment) as well as to minimize the temperature of the outer surface of the secondary housing 200. In some embodiments, an air gap 343 (FIG. 17) may be provided between an outer surface of an insulating layer (an initial outer surface of the combustion chamber) and the outer surface of the overall secondary housing. This air gap 343 allows for outside air to flow across the outer surface of the insulating layer (or outer surface of the combustion chamber), which removes some heat therefrom, which helps to minimize the surface temperature of the outer surface 201 of the secondary housing 200.

In other embodiments, a door may be provided between the storage space 340 and the combustion chamber 310, which can be periodically opened (either automatically based upon sensed parameters or duty cycle by the controller 1000, or manually opened by the operator) to allow combustion material to fall from the storage space 340 and into the combustion chamber 310.

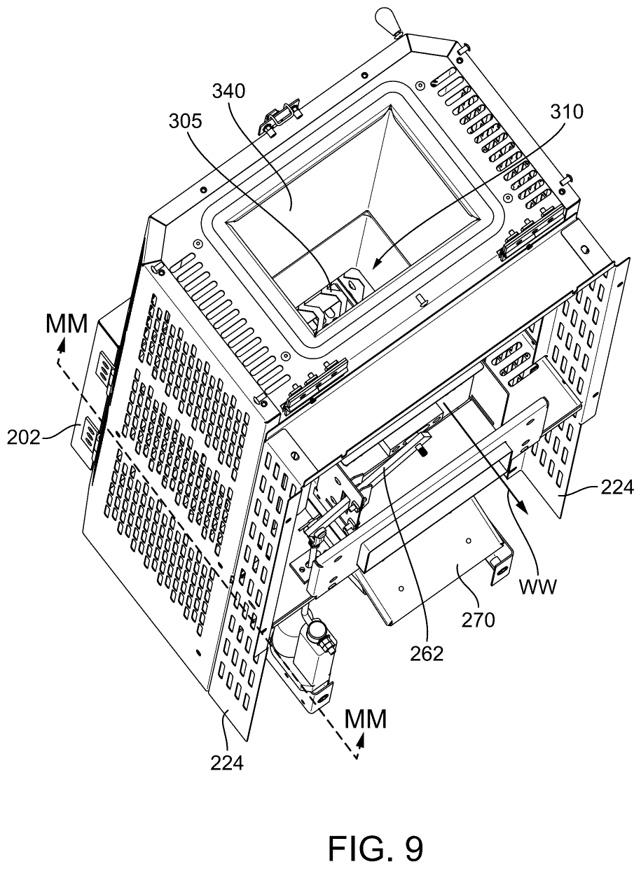

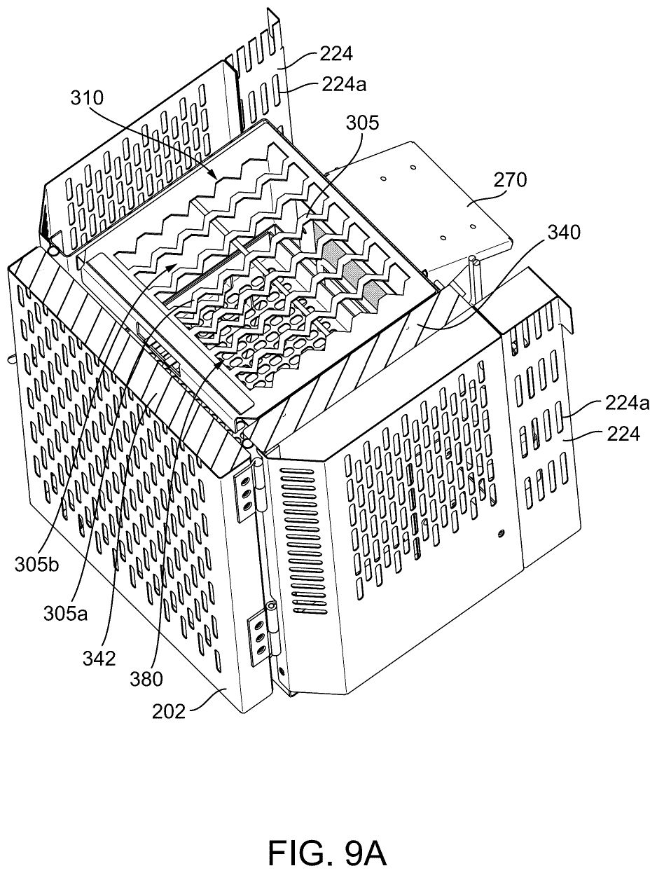

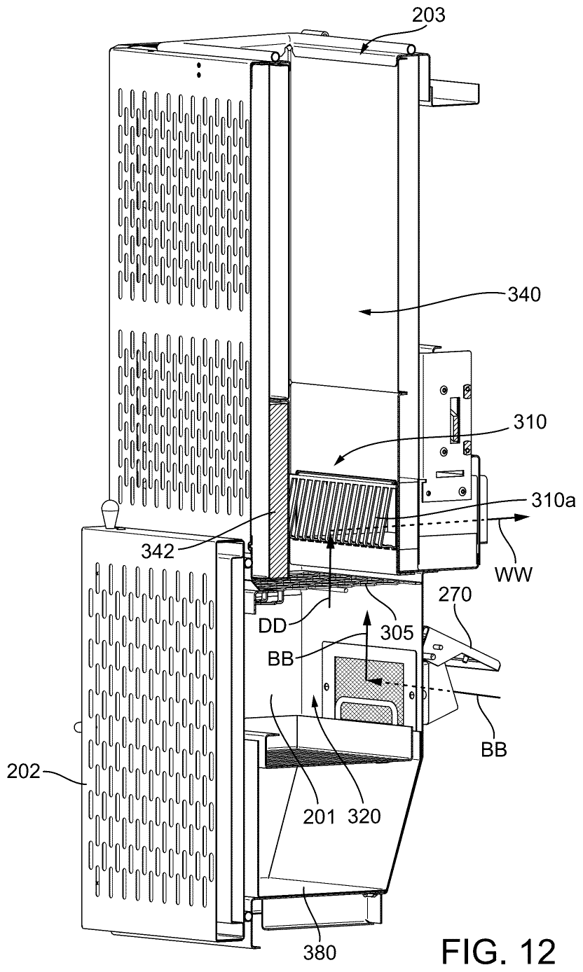

An auxiliary chamber 380 may be provided within the secondary housing 200 and positioned below the combustion chamber 310. The auxiliary chamber 380 may be separated by a rack 305. The rack 305 is best shown in FIGS. 9A, 13, and 14-14A. The rack 305 is the surface that combustible material rests upon within the combustion chamber 310. The rack 305 has a plurality of apertures 305b that are disposed as spaces between the solid portions 305a of the rack. The apertures 305b are provided to allow for air to flow upwardly therethrough from an air inlet portion 320 and into the combustion chamber (air flow DD, FIG. 12, schematic). The air inlet portion 320 receives air from the air inlet 190 when the door 270 is in an open position (as discussed below), and the air flows from the air inlet portion 320 upwardly through the rack 305 and into the combustion chamber 310 to supply oxygen into the combustion chamber 310 to maintain the combustible material burning within the combustion chamber 310. The apertures 305b are also provided (and sized) to allow small pieces of combustible material (as the combustible material breaks apart and becomes smaller with continued burning) to fall therethrough and into the auxiliary chamber 380 disposed below the rack 305 and the combustion chamber 310 (FIG. 17, HH, schematic). In some embodiments, the air inlet portion 320 may be an upper portion of the auxiliary chamber 380. The apertures 305 therefore allow the small pieces of combustible material to fall therethrough, and therefore maintain the bottom surface of the rack 305 unobstructed for combustion air flow therethrough (DD, FIG. 12, schematic).

The secondary housing 200 may have two doors, a top door 204 and a side door 202. The top door 204 is pivotably mounted upon the housing and when opened allows for access to the combustion chamber 310 and to the storage chamber 340 from above. The top door 204 is provided to, when open, allow for placing combustible material within the combustion chamber 310 and the storage space 340, which as discussed above may be separate compartments, or areas within one large vertical compartment. The top door 204 when closed encloses the combustion chamber 310 and the storage space 340 to prevent smoke from leaving through the top opening 203 into the secondary housing 200 and to minimize heat loss through the top opening 203 when the top door 204 is shut. If needed, the top door 204 can be opened during combustion operations within the secondary housing 200 to add combustible material into the combustion chamber 310/storage space 340.

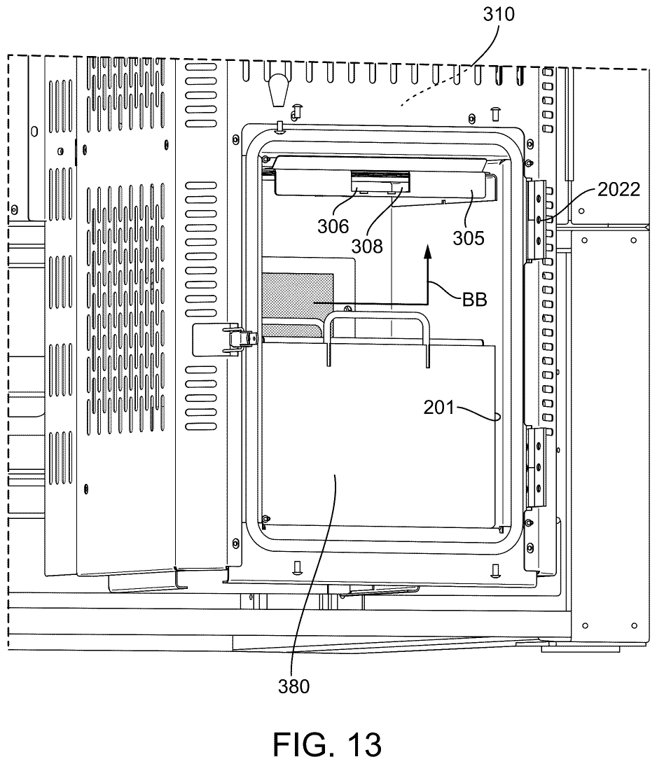

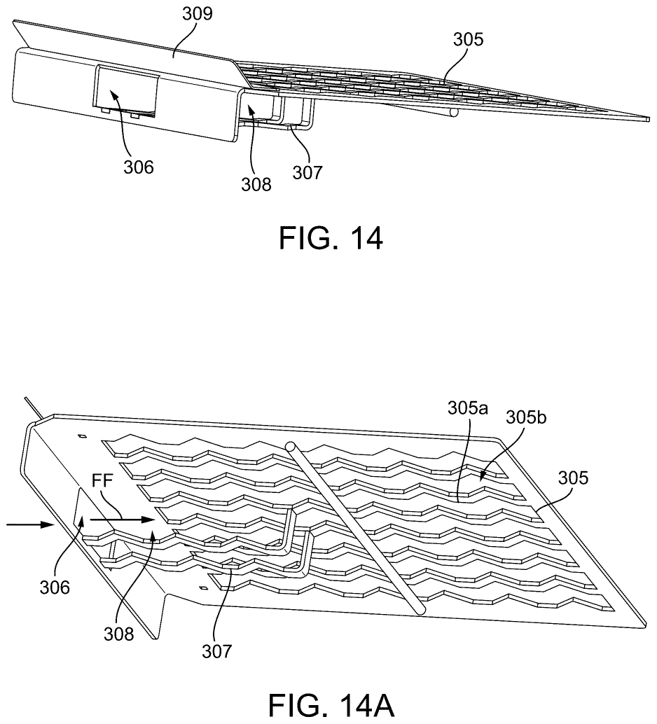

The side door 202 is provided to close or allow access to a side opening 201 within the secondary housing 200. The side opening 201 may be positioned below the combustion chamber 310 but aligned with the rack 305 such that the rack 305 can be slid from an installed position (below the combustion chamber 310 such that the lower most combustion material within the combustion chamber 310 rests upon the rack 305), and a withdrawn position (where the rack 305 is slid out of the page from the perspective of FIG. 13) to allow the rack to be partially or in some embodiments completely slid out of the secondary housing 200 for cleaning or other reasons. In some embodiments, the rack includes a handle portion 309 and an aperture 306 upon a side surface of the rack 305. The rack 305 may include a lower set of bars 307 that are below the upper surface of the rack with the space 308 defined there between. The space 308 may be provided to support an igniter therein which can be initially burned (such as kindling, paper, or other materials configured to be readily ignited), such that when the starting material within the space 308 burns, the flame that extends upwardly from the space 308 and through the apertures 305b in the rack tend to ignite the combustible material that rests upon and above the rack 305. The presence of the aperture 306 allows the igniter to be slid therethrough and into the space 308 as depicted with arrows FF (FIG. 14A), and allows the igniter to be lit through the aperture 306, such as by sticking a burning match or a flame generator through the aperture 306 to ignite the igniter within the space 308. This allows the igniter to be installed within the space 308 when the rack 305 is positioned and the combustible material positioned upon the rack 305 within the combustion chamber 200 (typically when the air inlet 190 is open as discussed below). Once the igniter has been ignited, the side door 202 may be closed to seal the secondary housing 200 to prevent heat and smoke from exiting the secondary housing through the side opening 201.

The side door 202 also allows access to the auxiliary chamber 380, which is positioned next to the side opening 201. When the side door 202 is opened, the auxiliary chamber 380 may be emptied (to remove the ash that accumulates within the auxiliary chamber 380 during operation. The auxiliary chamber 380 may support a container that can be completely removed from the side opening 201 when the side door 202 is open, which allows convenient removal of the ash and small unburned combustible material pieces that fell into the auxiliary chamber 380. In some embodiments, the auxiliary chamber 380 may include a space (or the entire space may be configured to) receive wood pellets (for example, or other combustible materials that are configured to provide a flavored smoke when burned) that are configured to provide a flavored smoke when burned, which when burned rises through the rack 305 and into the combustion chamber 310 and when the door 230 is opened flows through the air outlet 180 and into the first housing 20—to provide a flavored smoke to the food products within the enclosure 30. The wood pellets tend to burn within the auxiliary chamber 380 due to burning ash or small burning pieces of combustible material falling through the rack 305.

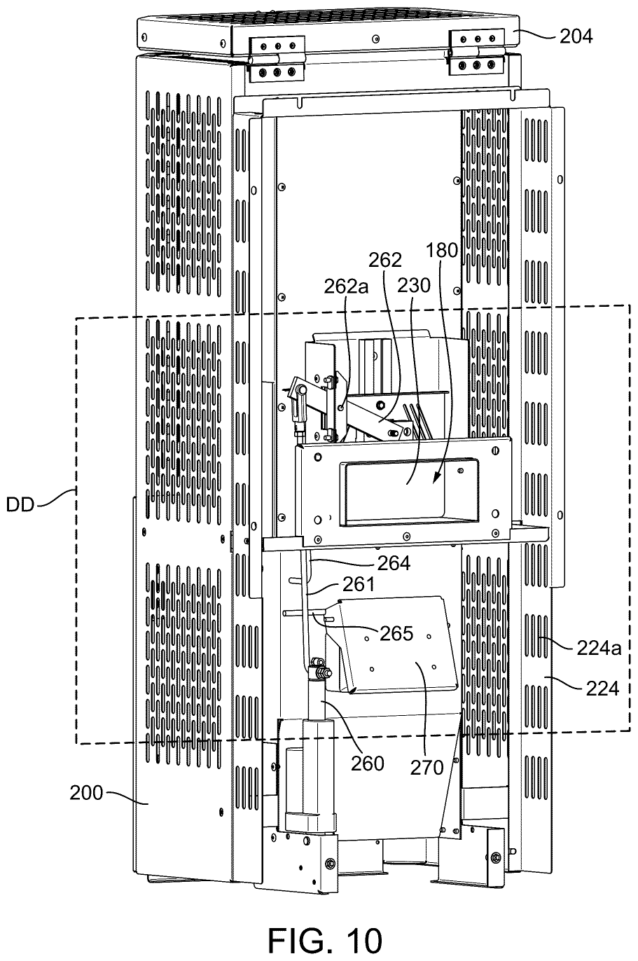

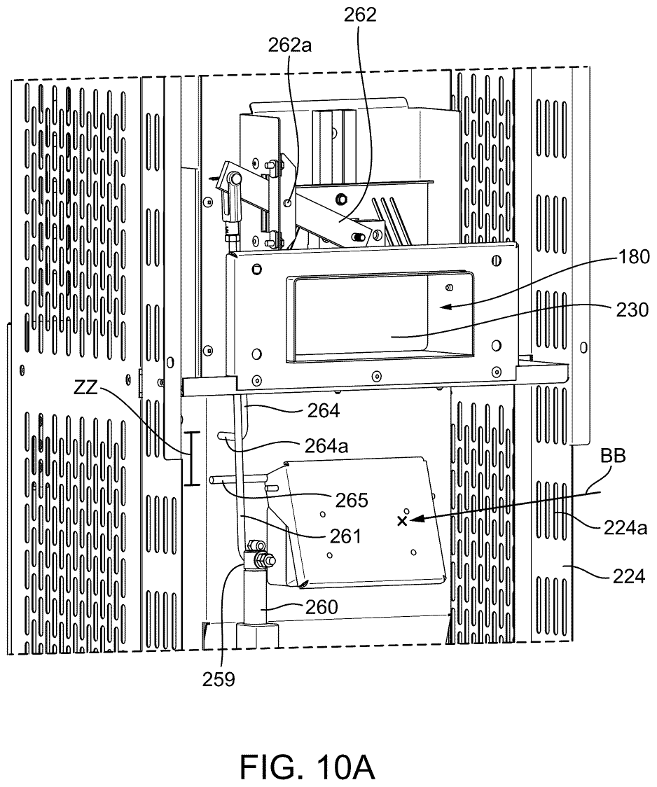

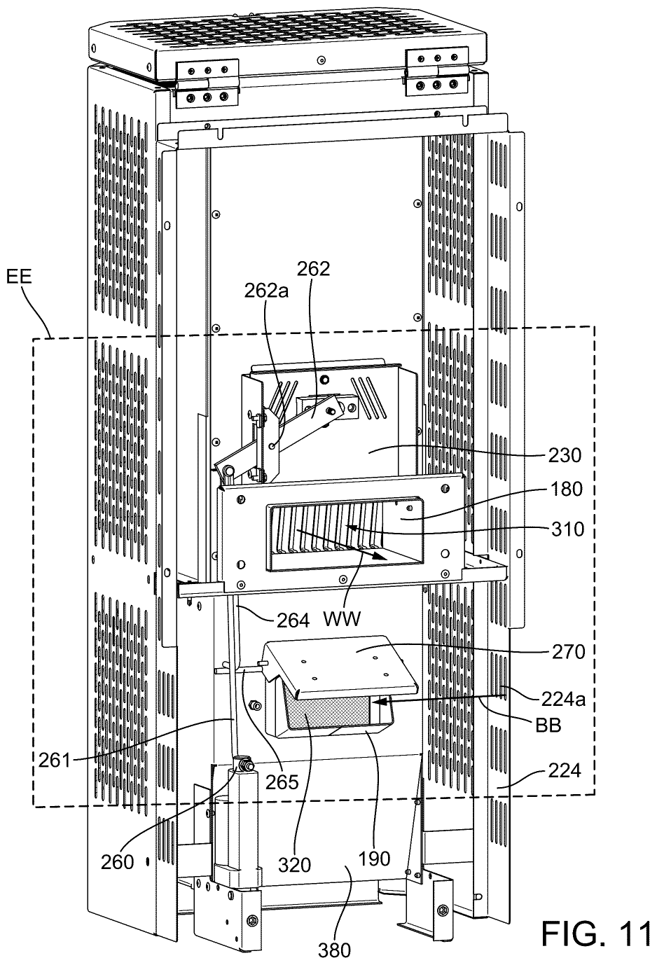

The air inlet 190 and the air outlet 180 of the secondary housing 200 are best understood with reference to FIGS. 9-12. The air outlet 180 leads into the combustion chamber 310 (with in some embodiments a screen 310a therebetween) and when a door 230 is in an open position (FIGS. 11, 11A) (or specifically when the door is not fully shut) allows air flow from the combustion chamber and into the air outlet 180 (air flow WW), which flows to the primary housing 20 and into the enclosure 30 as discussed above. When the door 230 is in the closed position (FIGS. 10, 10A) air is prevented (including substantially prevented) from flowing from the combustion chamber 310 and into the air outlet 180. The term “substantially prevented” is defined herein to include completely prevented as well as allowing a di minimius amount of air flow, such as due to improper seating of the door 230 in the closed position, tolerance buildups that allow for small an unintended gaps that allow flow, and for wear of parts over time. The air outlet 180 is positioned in registry with the combustion chamber 310 so that, during operation, hot combustion air and smoke flows directly from the combustion chamber 310 to the air outlet 180 (with the door in the open position).

The air inlet 190 is provided an allows fresh air (i.e. air flowing into the secondary housing 200 from the environment surrounding the secondary housing 200 as discussed above) to flow into the secondary housing 200 when the door 270 is open (or more specifically not fully shut). The air inlet 190 may direct air into an inlet portion 320 of the secondary housing 200 (air flow BB, FIGS. 11, 11A, 12), which may be directly below the combustion chamber 310 and directly below the rack 310. During combustion operation within the combustion chamber 310, air that flows into the inlet portion 320 is drawn upwardly and through the apertures 305b in the rack and into the combustion chamber 310 (air flow DD, FIG. 12), to provide replacement air (oxygen) to allow for continued combustion of the combustible material within the combustion chamber 310.

In the embodiments depicted in FIGS. 9-12 and 18-18A, the outlet door 270 and the inlet door 230 may be operated in concert with each other via the same door operating mechanism. In other embodiments, each door 230, 270 may have its own operable mechanism to independently control the position of each door (i.e. closed to prevent or substantially prevent air flow through the respective opening or partially to fully open to allow air flow through the respective opening). The positions of the independently operable doors 230, 270 may be controlled by the controller 1000.

In the embodiments depicted in FIGS. 9-12, the outlet door 270 and the inlet door 230 are controlled via the same mechanism 259 so that both doors are at consistent positions with respect to each other during the range of operation.

The door operation mechanism is best understood with reference to FIGS. 10A and 11A. The mechanism 259 includes an actuator 260 that is the input to the mechanism to cause the various components of the mechanism to move as desired. In some embodiments, the actuator 260 may be a linear actuator that includes a movable rod 261 that translates linearly upwardly and downwardly within the secondary housing 200. The end of the rod 261 is connected to a lever arm 262, which may be fixed to the housing with a pinned connection 262a, such that the lever arm 262 on both sides of the pinned connection. A first side of the pinned connection 262 is attached to the rod, and the lever arm 262 on the opposite side of the pinned connection 262a is connected to the door 230. Accordingly, when the rod 261 moves upwardly (with respect to the fixed operator 260, in the configuration of FIGS. 10A and 11A), the lever arm rotates in the clockwise direction (from the perspective of FIGS. 10A and 11A) such that the door moves in the downward direction. Alternatively, when the rod 261 moves in the downward direction (with respect to the fixed operator 260) the lever arm rotates in the counter-clockwise direction such that the door moves in the upward direction to move the door toward and to the open position to allow air flow (WW) through the outlet opening 180). One of ordinary skill in the art with a thorough review and understanding of this specification will readily comprehend that the relative position of the various components of the mechanism 259 can be altered (such that various components move in different directions than discussed herein) and still be within the scope of this disclosure.

The lever arm 262 may support a second rod 264 that is aligned to linear move with rotation of the lever arm 262, with the second rod 264 interacting with the second door 270 to cause the second door 270 to change positions. In the embodiment depicted in the figures, the second rod 264 is disposed upon the lever arm on the same side of the pinned connection 262a as the rod 261 so that the rod 261 and the second rod 264 move in the same direction. Alternatively, the second rod 264 may be fixed to the first rod 261 so that both the first and second rods 261, 264 move together with movement of the actuator 260.

As depicted in FIGS. 10-11A in some embodiments, the doors 230 and 270 are aligned to move at different times during the range of motion of the input (260), due to the different needs for air flow (inlet and outlet). Specifically, in some embodiments—and specifically the embodiment depicted in the figures, the door 230 for the air outlet 180 moves between the fully open position (FIGS. 11, 11A) and the fully closed position (FIGS. 10, 10A) between the total possible movement of the rod 261 (as urged to move linearly by the operator 260), while the door 270 (for the air inlet 190) only moves for a portion of the range of motion the rod 261. Specifically, when the door 270 is in the closed position (FIGS. 10, 10A) and when the door 230 is also in the closed position, as the rod 261 moves downwardly (from the FIG. 10A position toward the FIG. 11A position) the door 230 immediately begins to move to the open position (due to rotation of the lever arm 262), but for a first portion of the downward travel of the rod 261, an end (264a) of the second rod 264 does not interact with the second door 270, and specifically an operator 265 of the second door 270, so that the second door 270 remains in the closed position. As depicted in FIG. 10, when the doors are in the closed position (and the rods are in their fully extended position—in the depicted embodiment, could be other positions for different configurations as discussed), there is a space between the end 264a of the second rod 264 and the operator 265 of the second door 270 so that the second rod 264 travels for a portion of its range before causing movement of the second door 270 via the operator 265. After a certain amount of linear motion of the first rod 261 and the second rod 264 (and specifically an end 264a, which may be a bent portion of the second rod 264), the second rod 264 interacts with the door 270 (operator 265) and with continued motion causes the second door 270 to begin opening. With full motion of the second rod 264 (and the first rod 261) the second door 270 reaches the fully open position (FIGS. 11, 11A). When it is desired to close the first and second doors 230, 270, the rod 261 moves in the opposite (in the depicted embodiment upward) direction, and the second rod 264 also moves in the opposite direction. With the movement the first and second doors 230, 270 each travel from their fully open position toward the closed position. The second door 270 (air inlet 190) reaches the fully closed position at an intermediate point of the travel of the second rod 264, and the first door 230 (air outlet 180) reaches the fully closed position at the end of the travel of the first rod 261 (FIGS. 10, 10A) and the operator 260.

In some embodiments, the second door 270 is biased to the closed position, such as by the weight of the second door itself, and in some embodiments by a spring. The second door 270 may be pivotably mounted to the secondary housing 200 and arranged so that the second door 270 hangs vertically thereon, which maintains the second door in the closed position. The second door 270 can rotate upon the pivot connection to expose a portion of the air inlet 190 and with full rotation of the second door 270 to fully expose the air inlet 190 as it is caused to rotate by the operator 265 receiving force from the second rod 264. When the second rod 264 is translated (upwardly in the embodiment depicted in the figures) the second door 270 is allowed to return toward and eventually to the closed position. In alternative embodiments, the second door 270, may be slidably mounted upon the housing 200, similar to the operation of the first door 230 as discussed below.

In some embodiments, the first door 230 may be slidably mounted upon the secondary housing 200, as depicted in the figures. The door 230 may be directly attached to the lever arm 262, or may be attached with an intermediate connection therebetween. As the lever arm 262 is rotated (due to movement of the rod 261, as discussed above), the first door 230 is slid with respect to the secondary housing 200 in the same direction. With motion of the first door from a closed position, motion (vertically upward as depicted in the figures, but the direction of motion can change with other arrangements and still be within the scope of this disclosure) of the first door 230 is also upward. With sufficient motion the outlet opening 180 (discussed above) becomes exposed, which allows for air from the combustion chamber 310 to flow therethrough. With full motion of the door 230 the outlet opening 180 is fully exposed. When the rod 261 is translated in the opposite direction, the first door 230 moves in the opposite direction which with motion begins to cover the outlet opening 180 minimizing the space for combustion air to flow therethrough. With full motion of the rod 261 the first door 230 covers the outlet opening preventing or substantially preventing air to flow therepast.

In some embodiments, the first door 230 is biased toward the closed position (FIGS. 10, 10A). The biasing may be due to the weight of the door, in embodiments where the force of gravity upon the first door acts upon the door toward the closed position, and/or may be with a spring or another biasing member to urge the first door 230 toward the closed position.

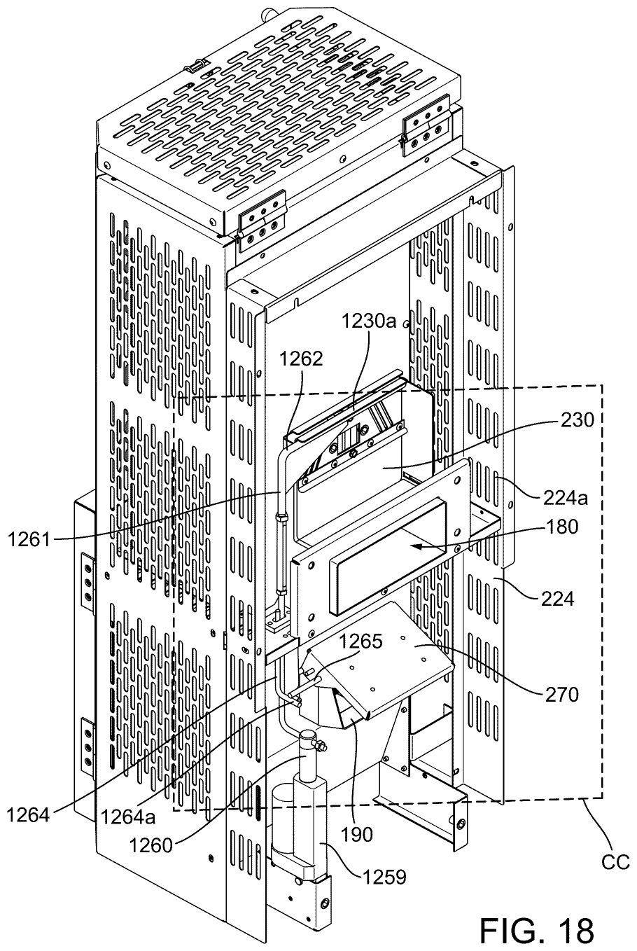

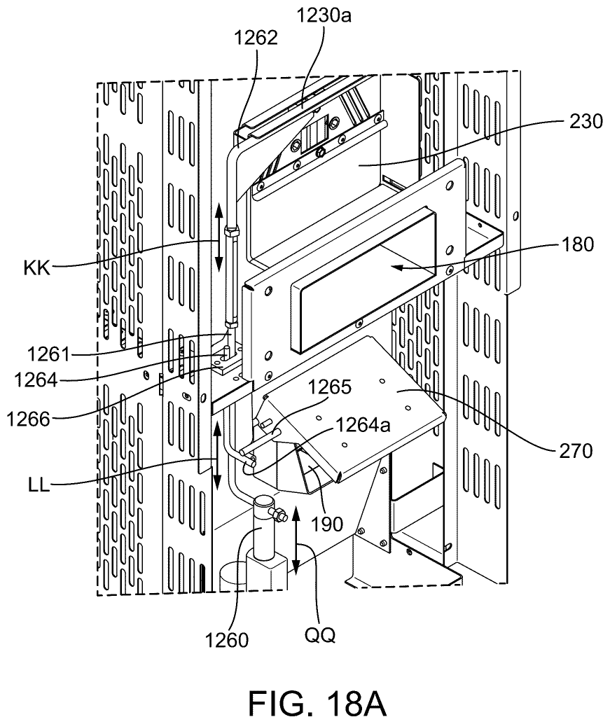

An alternate mechanism 1259 to control the position of the first and second doors is provided in FIGS. 18 and 18A. The mechanism operates similarly to the mechanism discussed above to cause the first and second doors 230, 270 to move between shut and open positions as desired, and in some embodiments as controlled by the controller 1000. The mechanism 1259 includes an actuator 1260 that is similar to actuator 260 and is the input to the mechanism to cause the various components of the mechanism to move as described herein. Movement of the actuator 1260 causes motion of the first rod 1261 in the same direction and speed as the actuator 1260. The end 1262 of the rod is connected to the first door 230 to cause the first door 230 to move linearly with motion of the rod 1261. In some embodiments, the end 1262 of the first rod 1261 projects in a direction different from a longitudinal axis of the first rod 1261, such as perpendicular to the linear axis through the first rod 1261. The end 1261 is fixed to the first door 230, such as extending through a hole in the first door 230 or via another connection to cause the first door 230 to move with linear motion of the first rod 1261. In the embodiment depicted in FIG. 18, the actuator 1260 is at a vertically upward position, which results in the first rod 1261 also being in the vertically upward position, and therefore the door 230 also being in a vertical upward position, which causes the first door 230 to clear the air outlet 180 to allow flow therethrough (similar to flow 11 (FIGS. 11, 11A).

The mechanism further includes a second rod 1264 that is either fixed directly to the first rod (as depicted in the figures) or may be fixed to an intermediate structure that is also fixed to the first rod 1261. The second rod is configured in the images depicted in FIGS. 18 and 18A to move in the same direction and speed as the first rod 1261. In other embodiments, the mechanism could be arranged such that the second rod moves in a different direction as the first rod such as when the first and second doors open and shut in different directions. In the embodiment depicted in FIGS. 18 and 18A the second rod 1264 is welded to the first rod 1261 so that the first and second rods 1261, 1264 move in unison. The housing may include a bracket 1266 with an aperture that the first and second rods 1261, 1264 slides through to support the position of the first and the second rods 1261, 1264 as they move together.

The second rod 1264 may include an end 1264a that is provided to interact with an operator 1265 that is connected to the second door 270. As can be understood with review of FIG. 18A, the second rod 1264 is positioned such that its end 1264a is below the operator 1265, and when the second rod 1264 is lifted (arrows LL) sufficiently it engages the operator 1265, and with motion of the operator 1265 as urged by the second rod 1264 causes the second door to rotate from a closed position toward an open position (as depicted in FIGS. 18 and 18A) to allow air to flow into the air inlet 190 of the secondary housing (as depicted as air flow BB in FIGS. 11 and 11A (schematic). The mechanism 1259 differs from the mechanism 259 in that in the mechanism 1259 the second rod 1264 causes the second door to open as the second rod moves upwardly (LL) and allows the second door 270 to close when the second rod moves downwardly (LL). As discussed above, the mechanism 259 is aligned with in the opposite manner such that downward movement of the second rod 264 causes the second door 270 to open and upward movement of the second rod 264 allows the second door to shut.

The mechanism 1259 is arranged similarly to the mechanism 259 in that when the first and doors are in a closed position, with initial motion of the first and second rods 1261, 1264, the first door begins to immediately move toward the open position, but the second door 270 does not move away from the closed position. With sufficient movement of the first and second rods 1261, 1264, the second rod 1264a engages the operator 1265 and with continued motion causes the second door to move (pivot in this embodiment) toward the open position. Similarly, when both doors 230, 270 are in the closed position, initial movement of the first and second rods 1261, 1264 in the opposite direction (LL, KK) both the first and second doors 230, 270 begin moving the closed position. The second door 270 reaches the closed position while the first door is in partially open position (and the second rod 1264 disengages the operator 1265 with further motion) and continued motion of the first and second rods 1261, 1264 continues until the first door 230 is in the fully shut position. In the shut position, the first and second rods and the operator 1261, 1264, 1260 are in a lower position than shown in FIG. 18, with the operator 1260 in a position similar to the operator 260 in FIGS. 10, 10A and with the first and second rods 1261, 1264 being lowered (LL, KK) a distance downward the same distance that the operator 1260 moves downward to obtain the position similar to the position depicted in FIGS. 10, 10A.

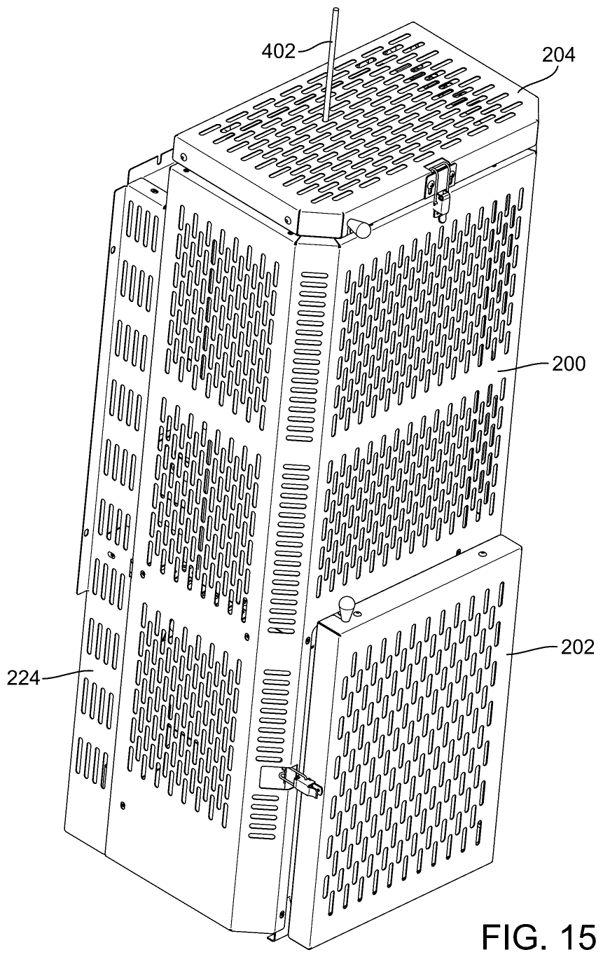

In some embodiments as depicted in FIGS. 15-17, the secondary housing 200 may include a follower 401 that is disposed therein that is configured to rest upon and cover the combustible material that is disposed within the combustion chamber 310 and the storage space 340. The follower 401 when provided, is configured to substantially enclose the top of either the combustion chamber 310 or in other embodiments the storage space 340 (when combustion material 9 is piled above the combustion chamber 310 and into the storage space 340—FIG. 17, schematic—depicting the combustible material stacked to a position just below the storage space, it can be understood with reference to FIG. 17, that the combustible material can be stacked higher into the storage space 340, with the follower 401 disposed above the top layer of the combustible material 9) to minimize the overall air volume therewithin. This has been determined to improve the operation of the secondary housing 200, by blocking air and heat flow upward from the combustion chamber 310 or the storage space 340. The follower 401 also may press downwardly upon the combustible material (due to the weight of the follower 401 or in some embodiments due to a spring or other structure that applies force to the follower) to maintain the combustible material organized within the combustion chamber 310 for desired combustion and heat generation. In some embodiments, the follower 401 may have an outer shape that is the same as the inner cross-sectional geometry of the combustion chamber 310 or the storage space 340, but just slightly smaller so that the follower 401 readily translates upwardly and downwardly within those spaces based upon the amount of combustible material currently within the secondary housing 200, but the follower is maintained in a position where its cross-section is parallel (or substantially parallel) to a plane through the rack 305 as the follower 401 moves downwardly within the secondary housing 200. In some embodiments, the follower 401 may be movably fixed to the secondary housing 200 to allow for manual position of the follower 401, and/or in other embodiments remotely operable positioning within the secondary housing 200. In one embodiment, the follower 401 may include a handle 402 that extends upwardly therefrom and extends upwardly through the upper door 204, to allow the follower 401 to be manually lifted or lowered when the upper door 204 is shut.

The system 10 is controlled by a controller 1000, which may be a single controller that operates all functions within the first housing and the secondary housing 10, 200, or may be multiple different controllers 1000 that are in communication with each other, and in some embodiments are all controlled by a master controller. For the sake of simplicity, a single controller 1000 is depicted schematically in the figures, but one of ordinary skill in the art will readily understand that the controller 1000 may be one or multiple components. The controller 1000 may have one or more sensors (e.g. 1002) that can sense various temperatures and air flows within or outside of the enclosure 30. The sensors 1002 may sense air temperature that flows through the plenums 34, 34, and/or may sense air temperature within the enclosure. The sensed air temperatures (and other sensed parameters, which would be readily apparent to one of ordinary skill in the art with a detailed review of this specification) are fed to the controller 1000, which controls operation of the electric heater 52, and/or fan 50 operation and speed to control the air flow and air temperature.

The controller 1000 also controls the operation of the actuator 260 that controls the position of the first and second doors 230, 270 within the secondary housing 200, as discussed above. When the controller identifies that more heat is needed within the enclosure, the controller causes the actuator 260 to move to open both the first door and the second door 230, 270 to allow combustion air to flow toward the enclosure. In some embodiments, the controller 1000 is configured to cause the first and second doors 230, 270 to fully open each opening cycle, while in some embodiments, the controller 1000 may be configured to allow the first door to only slightly open to allow only a small amount of combustion air into the air outlet 180 and to flow to the enclosure.

The controller 1000 may further monitor the status of combustion within combustion chamber 310 with one or more sensors (temperature, flame, or the like). The controller 1000 may operate the actuator to cause the second door 270 to open when the controller determines that additional combustion air is needed within the combustion chamber. In some embodiments, a sensor (such as a weight sensor) may be provided to determine the amount of combustible material (9) upon the rack 305, and when needed can give a signal (such as on the display 28) that additional combustible material (9) needs to be added to the secondary housing 200. The controller 1000 may take inputs from an input device 29, and may cause various parameters, timers, input requests, alarms, etc. to display upon the display. The controller 1000 may be programmed with various recipes to cause specific temperature and air flow programs within the enclosure based upon the type of food product received within the enclosure 30, and/or may be manually operated as directed by the user via the input device 29. In some embodiments, the controller 1000 may communicate with a remote display and input device to allow for remote control and monitoring of the system 10.

The term “about” is specifically defined herein to include a range that includes the reference value and plus or minus 5% of the reference value. The term “substantially the same” is when the item under comparison is within 5% of the aspect of the reference value of the item. The term “substantially” is when the referenced value or referenced aspect is within 5% of the reference value. For example, if the referenced item is an angle, something is substantially at that angle if it is within plus or minus 5% of the angle. The term “substantially” referenced with respect to a state (e.g. a path being substantially blocked) means that referenced state is blocked but may allow for di minimus flow therepast. The term “substantially” is when the term under comparison is not the exact same item (such as shape or length) as mentioned but with only di minimus changes from the referenced item as those di minimus changes would be appreciated by one or ordinary skill in the art, such as changes that do not significantly affect the structure of function of the item.

The computing elements or functions disclosed herein may include a processor and a memory storing computer-readable instructions executable by the processor. In some embodiments, the processor is a hardware processor configured to perform a predefined set of basic operations in response to receiving a corresponding basic instruction selected from a predefined native instruction set of codes. Each of the modules defined herein may include a corresponding set of machine codes selected from the native instruction set, and which may be stored in the memory. Embodiments can be implemented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, optical disc, memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described embodiments can also be stored on the machine-readable medium. Software running from the machine-readable medium can interface with circuitry to perform the described tasks. Moreover, embodiments may be implemented on application specific integrated circuits (ASICs) or very large scale integrated (VLSI) circuits. In fact, persons of ordinary skill in the art may utilize any number of suitable structures capable of executing logical operations according to the embodiments.

Naturally, in view of the teachings and disclosures herein, persons having ordinary skill in the art may appreciate that alternate designs and/or embodiments of the invention may be possible (e.g., with substitution of one or more components for others, with alternate configurations of components, etc.). Although some of the components, relations, configurations, and/or steps according to the invention are not specifically referenced and/or depicted in association with one another, they may be used, and/or adapted for use, in association therewith. All of the aforementioned and various other structures, configurations, relationships, utilities, any which may be depicted and/or based hereon, and the like may be, but are not necessarily, incorporated into and/or achieved by the invention. Any one or more of the aforementioned and/or depicted structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention

While the preferred embodiments of the disclosed have been described, it should be understood that the invention is not so limited and modifications may be made without departing from the disclosure. The scope of the disclosure is defined by the appended claims, and all devices that come within the meaning of the claims, either literally or by equivalence, are intended to be embraced therein.

The subject specification can be readily understood with reference to the following Numbered Paragraphs:
Numbered Paragraph 1: A cabinet configured to warm and/or hold warmed food product, comprising:
   a housing with an enclosure to receive and retain a food product therein in a warmed condition, the housing supporting a door that can be disposed in an open position to allow access to the enclosure and can be disposed in a closed position to prevent access to the enclosure;
   the enclosure further comprising a left side wall, a right side wall, a rear wall, a ceiling and a floor, a first air flow path established outside of the left side wall, a second air flow path established outside of the right side wall, a third air flow path established outside of the rear wall, and a fourth air flow path established within the door,
   an air flow plenum disposed above the ceiling, and configured to receive air that flows upwardly through the third air flow path when the door is in the closed position and the fourth air flow path;
   a fan disposed within the housing, the fan disposed above the ceiling and configured to, when operating, to draw suction from the air flow plenum, the fan further configured to discharge air into the first air flow path and the second air flow path in parallel.
Numbered Paragraph 2: The cabinet of Numbered Paragraph 1, wherein the left side wall comprises a plurality of openings therethrough that allow air to flow from the first air flow path and into the enclosure, and the right side wall comprises a plurality of openings therethrough that allow air to flow from second air flow path and into the enclosure.
Numbered Paragraph 3: The cabinet of Numbered Paragraph 2, wherein the left and right side walls each include a plurality of supports thereon, the supports are configured to receive a plurality of pans thereon, wherein some or all of the plurality of openings in the respective left and right walls are disposed to expel air into the enclosure above supports aligned therewith.
Numbered Paragraph 4: The cabinet of any one of Numbered Paragraphs 1-3, further comprising a receipt plenum disposed below the floor, the receipt plenum configured to receive air from a second housing outboard of and attached to the housing, wherein the receipt plenum directs air received therein to flow into the third air flow path when the door is in the closed position and into the fourth air flow path.
Numbered Paragraph 5: The cabinet of any one of Numbered Paragraphs 1-4, further comprising a second housing outboard of and attached to the housing,
   the second housing comprising a combustion chamber disposed therein, and a first outlet that is fluidly connected to a receipt plenum of the housing, the second housing further comprising an air inlet that allows outside enter to enter into the combustion chamber.
Numbered Paragraph 6: The cabinet of Numbered Paragraph 5, further comprising a first door that is disposed proximate to the first outlet, such that when the first door is in an open position air can flow from the combustion chamber to the receipt plenum and when the first door is in a closed position air is prevented from flowing from the combustion chamber to the receipt plenum, and
   further comprising a second door that is disposed proximate to the air inlet, such that when the second door is in an open position air can flow from outside of the second housing and into the second housing, and when the second door is in a closed position air is prevent from flowing into the second housing, wherein
   the first door and the second door are operated concurrently such that the first and second doors are both in the closed position or the first and second doors are both in a fully open position.
Numbered Paragraph 7: The cabinet of Numbered Paragraph 6, further comprising a door operating mechanism that controls the position of the first and second doors, the door operating mechanism comprising an actuator, a shaft that is linearly translated with motion of the actuator, a lever arm that rotates with motion of the shaft, and a second shaft.
Numbered Paragraph 8: The cabinet of Numbered Paragraph 7, wherein the lever arm is fixed to the first door such that rotation of the lever arm results in linear motion of the first door.
Numbered Paragraph 9: The cabinet of Numbered Paragraph 7, wherein the second shaft linearly translates with motion of the actuator, wherein during a first portion of a total range of travel of the second shaft the second shaft contacts an input of the second door such that movement within the first portion of range of travel causes movement of the second door, wherein along a remaining portion of the total range of travel of the second shaft the second shaft does not contact the input of the second door such that the second door is not moved with motion of the remaining portion of the second shaft.
Numbered Paragraph 10: The cabinet of Numbered Paragraph 7, wherein the first door is biased to the closed position and the second door is biased to the closed position, wherein rotation of the lever arm causes motion of the first door and wherein motion of the second shaft along a portion of a total range of travel of the second shaft in a first direction causes motion of the second door from a closed position toward an open position, wherein motion of the second shaft in an opposite direction within the portion of the total range of travel of the second shaft allows the second door to move toward the closed position.
Numbered Paragraph 11: The cabinet of any one of Numbered Paragraphs 6-10, wherein the second housing comprises an outer housing therearound, the second housing disposed at a distance aligned outboard of the walls of the combustion chamber, wherein the outer housing comprises a plurality of holes therein, wherein the plurality of holes allow for air to flow therethrough to flow into the air inlet when the second door is in the open position.
Numbered Paragraph 12: The cabinet of any one of Numbered Paragraphs 5-11, wherein the second housing further comprises a combustible material storage compartment disposed above the combustion chamber, wherein combustible material disposed within the combustion chamber is burned when ignited and combustible material disposed above the combustion chamber within the storage compartment has a tendency to not burn when disposed therein, wherein as combustible material within the combustion chamber breaks into smaller pieces, combustible material within the storage compartment tends to fall due to gravity into the combustion chamber which is in turned burned within the combustion chamber.
Numbered Paragraph 13: The cabinet of Numbered Paragraph 12, further comprising a storage chamber disposed below the combustion chamber, and a support surface disposed between the storage chamber and the combustion chamber, wherein the support surface comprises a plurality of apertures therein, wherein the plurality of apertures are configured to support combustible material thereon that is with a size that is larger than an aspect ratio of the plurality of apertures and when the combustible material has the aspect ratio that is smaller than the plurality of apertures the combustible material is configured to fall through the aperture aligned therewith.
Numbered Paragraph 14: The cabinet of Numbered Paragraph 13, wherein the support surface is slidable with respect to the combustion chamber between an installed position and a removed position, wherein the support surface comprises a second support portion disposed blow the support surface, the second support portion configured to receive a burning material that when the support surface is within the combustion chamber combustible material that is disposed within the combustion chamber upon the support surface is configured to be ignited.
Numbered Paragraph 15: The cabinet of Numbered Paragraph 14, further comprising an access door disposed upon the second housing, wherein when the access door is opened the support surface can be moved to the removed position, and when the access door is in the open position materials within the storage chamber can be removed from the second housing.
Numbered Paragraph 16: The cabinet of any one of Numbered Paragraphs 11-15, further comprising a follower disposed within the second housing and configured to rest upon combustible material that is disposed within the combustion chamber or combustible material when present within the storage compartment, wherein the follower is configured to move within the second housing as a top most layer of combustible material within the combustion chamber or when combustible material is present within the storage compartment moves downwardly within the respective combustion chamber or storage compartment.
Numbered Paragraph 17: The cabinet of Numbered Paragraph 16, wherein the follower is configured with outer edges that are disposed proximate to or in contact with adjacent inner walls of the housing to substantially prevent air flow vertically from the combustion chamber past the outer edges of the follower.
Numbered Paragraph 18: A holding cabinet configured to warm and/or hold warmed food product, comprising:
   a first housing with an enclosure to receive and retain food product therein in a warmed condition, and
   a second housing outboard of and attached to the housing,
   the second housing comprising a combustion chamber disposed therein, and a first outlet that is fluidly connected to the first housing, the first outlet configured to allow air from the combustion chamber to flow into the enclosure, the second housing further comprising an air inlet that allows outside enter to enter into the combustion chamber,
   the second housing further comprising a first door that is disposed proximate to the first outlet, such that when the first door is in an open position air can flow from the combustion chamber toward the enclosure and when the first door is in a closed position air is prevented from flowing from the combustion chamber toward the enclosure, and
   further comprising a second door that is disposed proximate to the air inlet, such that when the second door is in an open position air can flow from outside of the second housing and into the second housing, and when the second door is in a closed position air is prevent from flowing into the second housing, wherein
   the first door and the second door are operated concurrently such that the first and second doors are both in the closed position or the first and second doors are both in the open position.
Numbered Paragraph 19: The cabinet configured to hold warmed food product of Numbered Paragraph 18, further comprising a door operating mechanism that controls the position of the first and second doors, the door operating mechanism comprising an actuator, a shaft that is linearly translated with motion of the actuator, a lever arm that rotates with motion of the shaft, and a second shaft.
Numbered Paragraph 20: The cabinet configured to hold warmed food product of Numbered Paragraph 19, wherein the second housing further comprises a combustible material storage compartment disposed above the combustion chamber, wherein combustible material disposed within the combustion chamber is burned when ignited and combustible material disposed above the combustion chamber has a tendency to not burn when disposed therein, wherein as combustible material within the combustion chamber and breaks into smaller pieces, combustible material within the storage compartment tends to fall due to gravity into the combustion chamber which is in turned burned within the combustion chamber.
Numbered Paragraph 21: The cabinet configured to hold warmed food product of Numbered Paragraph 20, further comprising a support surface disposed between the storage compartment and the combustion chamber, wherein the support surface comprises a plurality of apertures therein, wherein the plurality of apertures are configured to support combustible material thereon that is with a size that is larger than an aspect ratio of the plurality of apertures and when the combustible material has the aspect ratio that is smaller than the plurality of apertures the combustible material is configured to fall through the aperture aligned therewith,
   wherein the support surface is slidable with respect to the combustion chamber between an installed position and a removed position, wherein the support surface comprises a second support portion disposed blow the support surface, the second support portion configured to receive a burning material that when the support surface is within the combustion chamber will ignite combustible material that is disposed within the combustion chamber upon the support surface.
Numbered Paragraph 22: The cabinet configured to hold warmed food product of any one of Numbered Paragraphs 20-21, further comprising a follower disposed within the second housing and configured to rest upon combustible material that is disposed within the combustion chamber or combustible material when present within the storage compartment, wherein the follower is configured to move within the second housing as a top most layer of combustible within the combustion chamber or when combustible material is present within the storage compartment moves downwardly within the respective combustion chamber or storage compartment.
   the second housing comprising a combustion chamber disposed therein, and a first outlet that is fluidly connected to a receipt plenum of the housing, the second housing further comprising an air inlet that allows outside enter to enter into the combustion chamber.
Numbered Paragraph 23: A cabinet configured to warm and/or hold warmed food product, comprising:
   a housing with an enclosure to receive and retain food product therein in a warmed condition,
   further comprising a second housing outboard of and attached to the housing,
   the second housing comprising a combustion chamber disposed therein, and a first outlet that is fluidly connected to a receipt plenum of the housing, the second housing further comprising an air inlet that allows outside enter to enter into the combustion chamber.
Numbered Paragraph 24: The cabinet of Numbered Paragraph 23, further comprising a first door that is disposed proximate to the first outlet, such that when the first door is in an open position air can flow from the combustion chamber to the receipt plenum and when the first door is in a closed position air is prevented from flowing from the combustion chamber to the receipt plenum, and
   further comprising a second door that is disposed proximate to the air inlet, such that when the second door is in an open position air can flow from outside of the second housing and into the second housing, and when the second door is in a closed position air is prevent from flowing into the second housing, wherein
   the first door and the second door are operated concurrently such that the first and second doors are both in the closed position or the first and second doors are both in a fully open position.
Numbered Paragraph 25: The cabinet of Numbered Paragraph 24, further comprising a door operating mechanism that controls the position of the first and second doors, the door operating mechanism comprising an actuator, a shaft that is linearly translated with motion of the actuator, a lever arm that rotates with motion of the shaft, and a second shaft.
Numbered Paragraph 26: The cabinet of Numbered Paragraph 25, wherein the lever arm is fixed to the first door such that rotation of the lever arm results in linear motion of the first door.
Numbered Paragraph 27: The cabinet of Numbered Paragraph 25, wherein the second shaft linearly translates with motion of the actuator, wherein a first portion of a total range of travel of the second shaft the second shaft contacts an input of the second door such that movement within the portion of range of travel causes movement of the second door, wherein along a remaining portion of the total range of travel of the second shaft the second shaft does not contact the input of the second door such that the second door is not moved with motion of the remaining portion of the second shaft.
Numbered Paragraph 28: The cabinet of Numbered Paragraph 25, wherein the first door is biased to the closed position and the second door is biased to the closed position, wherein rotation of the lever arm causes motion of the first door and wherein motion of the second shaft along a portion of a total range of travel of the second shaft in a first direction causes motion of the second door from a closed position toward an open position, wherein motion of the second shaft in an opposite direction within the portion of the total range of travel of the second shaft allows the second door to move toward the closed position.
Numbered Paragraph 29: The cabinet of any one of Numbered Paragraphs 24-29, wherein the second housing comprises an outer housing therearound, the second housing disposed at a distance aligned outboard of the walls of the combustion chamber, wherein the outer housing comprises a plurality of holes therein, wherein the plurality of holes allow for air to flow therethrough to flow into the air inlet when the second door is in the open position.
Numbered Paragraph 30: The cabinet of any one of Numbered Paragraphs 23-30, wherein the second housing further comprises a combustible material storage compartment disposed above the combustion chamber, wherein combustible material disposed within the combustion chamber is burned when ignited and combustible material disposed above the combustion chamber within the storage compartment has a tendency to not burn when disposed therein, wherein as combustible material within the combustion chamber and breaks into smaller pieces, combustible material within the storage compartment tends to fall due to gravity into the combustion chamber which is in turned burned within the combustion chamber.
Numbered Paragraph 31: The cabinet of Numbered Paragraph 30, further comprising a storage chamber disposed below the combustion chamber, and a support surface disposed between the storage chamber and the combustion chamber, wherein the support surface comprises a plurality of apertures therein, wherein the plurality of apertures are configured to support combustible material thereon that is with a size that is larger than an aspect ratio of the plurality of apertures and when the combustible material has the aspect ratio that is smaller than the plurality of apertures the combustible material is configured to fall through the aperture aligned therewith.
Numbered Paragraph 32: The cabinet of Numbered Paragraph 31, wherein the support surface is slidable with respect to the combustion chamber between an installed position and a removed position, wherein the support surface comprises a second support portion disposed blow the support surface, the second support portion configured to receive a burning material that when the support surface is within the combustion chamber will ignite combustible material that is disposed within the combustion chamber upon the support surface.
Numbered Paragraph 33: The cabinet of Numbered Paragraph 32, further comprising an access door disposed upon the second housing, wherein when the access door is opened the support surface can be moved to the removed position, and when the access door is in the open position materials within the storage chamber can be removed from the second housing.
Numbered Paragraph 34: The cabinet of any one of Numbered Paragraphs 29-33, wherein further comprising a follower disposed within the second housing and configured to rest upon combustible material that is disposed within the combustion chamber or combustible material when present within the storage compartment, wherein the follower is configured to move within the second housing as a top most layer of combustible material within the combustion chamber or when combustible material is present within the storage compartment moves downwardly within the respective combustion chamber or storage compartment.
Numbered Paragraph 35: The cabinet of Numbered Paragraph 34, wherein the follower is configured with outer edges that are disposed proximate to or in contact with adjacent inner walls of the housing to substantially prevent air flow vertically from the combustion chamber past the outer edges of the follower.

1. A cabinet configured to warm and/or hold warmed food product, comprising:
a housing with an enclosure to receive and retain a food product therein in a warmed condition, the housing supporting a door that can be disposed in an open position to allow access to the enclosure and can be disposed in a closed position to prevent access to the enclosure;
the enclosure further comprising a left side wall, a right side wall, a rear wall, a ceiling and a floor, a first air flow path established outside of the left side wall, a second air flow path established outside of the right side wall, a third air flow path established outside of the rear wall, and a fourth air flow path established within the door,
an air flow plenum disposed above the ceiling, and configured to receive air that flows upwardly through the third air flow path when the door is in the closed position and the fourth air flow path;
a fan disposed within the housing, the fan disposed above the ceiling and configured to, when operating, to draw suction from the air flow plenum, the fan further configured to discharge air into the first air flow path and the second air flow path in parallel.

2. The cabinet of claim 1, wherein the left side wall comprises a plurality of openings therethrough that allow air to flow from the first air flow path and into the enclosure, and the right side wall comprises a plurality of openings therethrough that allow air to flow from second air flow path and into the enclosure.

3. The cabinet of claim 2, wherein the left and right side walls each include a plurality of supports thereon, the supports are configured to receive a plurality of pans thereon, wherein some or all of the plurality of openings in the respective left and right walls are disposed to expel air into the enclosure above supports aligned therewith.

4. The cabinet of claim 1, further comprising a receipt plenum disposed below the floor, the receipt plenum configured to receive air from a second housing outboard of and attached to the housing, wherein the receipt plenum directs air received therein to flow into the third air flow path when the door is in the closed position and into the fourth air flow path.

5. The cabinet of claim 1, further comprising a second housing outboard of and attached to the housing,
the second housing comprising a combustion chamber disposed therein, and a first outlet that is fluidly connected to a receipt plenum of the housing, the second housing further comprising an air inlet that allows outside enter to enter into the combustion chamber.

6. The cabinet of claim 5, further comprising a first door that is disposed proximate to the first outlet, such that when the first door is in an open position air can flow from the combustion chamber to the receipt plenum and when the first door is in a closed position air is prevented from flowing from the combustion chamber to the receipt plenum, and
further comprising a second door that is disposed proximate to the air inlet, such that when the second door is in an open position air can flow from outside of the second housing and into the second housing, and when the second door is in a closed position air is prevent from flowing into the second housing, wherein
the first door and the second door are operated concurrently such that the first and second doors are both in the closed position or the first and second doors are both in a fully open position.

7. The cabinet of claim 6, further comprising a door operating mechanism that controls the position of the first and second doors, the door operating mechanism comprising an actuator, a shaft that is linearly translated with motion of the actuator, a lever arm that rotates with motion of the shaft, and a second shaft.

8. The cabinet of claim 7, wherein the lever arm is fixed to the first door such that rotation of the lever arm results in linear motion of the first door.

9. The cabinet of claim 7, wherein the second shaft linearly translates with motion of the actuator, wherein during a first portion of a total range of travel of the second shaft the second shaft contacts an input of the second door such that movement within the first portion of range of travel causes movement of the second door, wherein along a remaining portion of the total range of travel of the second shaft the second shaft does not contact the input of the second door such that the second door is not moved with motion of the remaining portion of the second shaft.

10. The cabinet of claim 7, wherein the first door is biased to the closed position and the second door is biased to the closed position, wherein rotation of the lever arm causes motion of the first door and wherein motion of the second shaft along a portion of a total range of travel of the second shaft in a first direction causes motion of the second door from a closed position toward an open position, wherein motion of the second shaft in an opposite direction within the portion of the total range of travel of the second shaft allows the second door to move toward the closed position.

11. The cabinet of claim 6, wherein the second housing comprises an outer housing therearound, the second housing disposed at a distance aligned outboard of the walls of the combustion chamber, wherein the outer housing comprises a plurality of holes therein, wherein the plurality of holes allow for air to flow therethrough to flow into the air inlet when the second door is in the open position.

12. The cabinet of claim 5, wherein the second housing further comprises a combustible material storage compartment disposed above the combustion chamber, wherein combustible material disposed within the combustion chamber is burned when ignited and combustible material disposed above the combustion chamber within the storage compartment has a tendency to not burn when disposed therein, wherein as combustible material within the combustion chamber breaks into smaller pieces, combustible material within the storage compartment tends to fall due to gravity into the combustion chamber which is in turned burned within the combustion chamber.

13. The cabinet of claim 12, further comprising a storage chamber disposed below the combustion chamber, and a support surface disposed between the storage chamber and the combustion chamber, wherein the support surface comprises a plurality of apertures therein, wherein the plurality of apertures are configured to support combustible material thereon that is with a size that is larger than an aspect ratio of the plurality of apertures and when the combustible material has the aspect ratio that is smaller than the plurality of apertures the combustible material is configured to fall through the aperture aligned therewith.

14. The cabinet of claim 13, wherein the support surface is slidable with respect to the combustion chamber between an installed position and a removed position, wherein the support surface comprises a second support portion disposed blow the support surface, the second support portion configured to receive a burning material that when the support surface is within the combustion chamber combustible material that is disposed within the combustion chamber upon the support surface is configured to be ignited.

15. The cabinet of claim 14, further comprising an access door disposed upon the second housing, wherein when the access door is opened the support surface can be moved to the removed position, and when the access door is in the open position materials within the storage chamber can be removed from the second housing.

16. The cabinet of claim 11, further comprising a follower disposed within the second housing and configured to rest upon combustible material that is disposed within the combustion chamber or combustible material when present within the storage compartment, wherein the follower is configured to move within the second housing as a top most layer of combustible material within the combustion chamber or when combustible material is present within the storage compartment moves downwardly within the respective combustion chamber or storage compartment.

17. The cabinet of claim 16, wherein the follower is configured with outer edges that are disposed proximate to or in contact with adjacent inner walls of the housing to substantially prevent air flow vertically from the combustion chamber past the outer edges of the follower.

18. A holding cabinet configured to warm and/or hold warmed food product, comprising:
a first housing with an enclosure to receive and retain food product therein in a warmed condition, and
a second housing outboard of and attached to the housing,
the second housing comprising a combustion chamber disposed therein, and a first outlet that is fluidly connected to the first housing, the first outlet configured to allow air from the combustion chamber to flow into the enclosure, the second housing further comprising an air inlet that allows outside enter to enter into the combustion chamber,
the second housing further comprising a first door that is disposed proximate to the first outlet, such that when the first door is in an open position air can flow from the combustion chamber toward the enclosure and when the first door is in a closed position air is prevented from flowing from the combustion chamber toward the enclosure, and
further comprising a second door that is disposed proximate to the air inlet, such that when the second door is in an open position air can flow from outside of the second housing and into the second housing, and when the second door is in a closed position air is prevent from flowing into the second housing, wherein
the first door and the second door are operated concurrently such that the first and second doors are both in the closed position or the first and second doors are both in the open position.

19. The cabinet configured to hold warmed food product of claim 18, further comprising a door operating mechanism that controls the position of the first and second doors, the door operating mechanism comprising an actuator, a shaft that is linearly translated with motion of the actuator, a lever arm that rotates with motion of the shaft, and a second shaft.

20. The cabinet configured to hold warmed food product of claim 19, wherein the second shaft linearly translates with motion of the actuator, wherein during a first portion of a total range of travel of the second shaft the second shaft contacts an input of the second door such that movement within the first portion of range of travel causes movement of the second door, wherein along a remaining portion of the total range of travel of the second shaft the second shaft does not contact the input of the second door such that the second door is not moved with motion of the remaining portion of the second shaft.
